(19) United States
(12) Patent Application Publication
(10) Pub. No.: US 2025/0238122 A1
(43) Pub. Date: Jul. 24, 2025

(54) INFORMATION PROCESSING APPARATUS, INFORMATION PROCESSING METHOD, AND PROGRAM

(71) Applicant: Sony Group Corporation, Tokyo (JP)

(72) Inventors: Yuji Tokozume, Tokyo (JP); Toru Chinen, Kanagawa (JP); Junichiro Otani, Tokyo (JP); Hirofumi Takeda, Kanagawa (JP)

(73) Assignee: Sony Group Corporation, Tokyo (JP)

(21) Appl. No.: 18/698,488

(22) PCT Filed: May 31, 2022
(86) PCT No.: PCT/JP2022/022046

§ 371 Date: Apr. 4, 2024

(30) Foreign Application Priority Data
Oct. 15, 2021 (JP) 2021-169605

(51) Int. Cl. G06F 3/0484; G06F 3/0482; G06F 3/16; H04S 7/00

(52) U.S. Cl. CPC G06F 3/0484; G06F 3/0482; G06F 3/165; H04S 7/30; H04S 2400/13

(57) ABSTRACT

The present technology relates to an information processing apparatus, an information processing method, and a program that enable creation of high-quality content.

An information processing apparatus includes a control unit that determines an output parameter forming metadata of an object of content on the basis of the content or one or a plurality of pieces of attribute information of the object of the content. The present technology can be applied to an automatic mixing apparatus.

### TECHNICAL FIELD

The present technology relates to an information processing apparatus, an information processing method thereof, and a program, and more particularly, to an information processing apparatus, an information processing method, and a program capable of creating high-quality content.

### BACKGROUND ART

For example, there is known a technology for automatically performing mixing of object audio, that is, determining three-dimensional position information, a gain, and the like of an object (see, for example, Patent Document 1). By using such a technology, a user can create content in a short time.

### CITATION LIST

### Patent Document

Patent Document 1: WO 2020/066681

### SUMMARY OF THE INVENTION

### Problems to be Solved by the Invention

Meanwhile, Patent Document 1 proposes a method for determining three-dimensional position information of an object using a decision tree, but it is not sufficient to consider features of sound important in mixing, and it is difficult to perform high-quality mixing. That is, it is difficult to obtain high-quality content.

The present technology has been made in view of such a situation, and enables creation of high-quality content.

### Solutions to Problems

An information processing apparatus according to one aspect of the present technology includes a control unit that determines an output parameter forming metadata of an object of content on the basis of the content or one or a plurality of pieces of attribute information of the object.

An information processing method or a program according to one aspect of the present technology includes a step of determining an output parameter forming metadata of an object of content on the basis of the content or one or a plurality of pieces of attribute information of the object.

In one aspect of the present technology, the output parameter forming the metadata of the object of the content is determined on the basis of the content or one or the plurality of pieces of attribute information of the object.

### BRIEF DESCRIPTION OF DRAWINGS

FIG. 1 is a diagram illustrating a configuration example of an information processing apparatus.

FIG. 2 is a diagram illustrating a configuration example of an automatic mixing apparatus.

FIG. 3 is a flowchart for describing automatic mixing processing.

FIG. 4 is a view for describing a specific example of calculation of an output parameter.

FIG. 5 is a view for describing calculation of a rise of a sound.

FIG. 6 is a view for describing calculation of duration.

FIG. 7 is a view for describing calculation of a zero-crossing rate.

FIG. 8 is a view for describing calculation of a note density.

FIG. 9 is a view for describing calculation of a reverb intensity.

FIG. 10 is a view for describing calculation of a time occupancy rate.

FIG. 11 is a view for describing an output parameter calculation function.

FIG. 12 is a view for describing approximate arrangement ranges of objects.

FIG. 13 is a view for describing adjustment of output parameters.

FIG. 14 is a view for describing adjustment of output parameters.

FIG. 15 is a view for describing adjustment of the output parameters.

FIG. 16 is a view illustrating an example of a user interface for adjusting internal parameters.

FIG. 17 is a view illustrating an example of a user interface for adjusting internal parameters.

FIG. 18 is a view illustrating an example of a user interface for adjusting internal parameters.

FIG. 19 is a view illustrating an example of a user interface for adjusting internal parameters.

FIG. 20 is a view illustrating an example of a user interface for adjusting internal parameters.

FIG. 21 is a view illustrating an example of a user interface for adjusting internal parameters.

FIG. 22 is a view illustrating an example of a user interface for adjusting internal parameters.

FIG. 23 is a view for describing adjustment of a graph shape.

FIG. 24 is a view illustrating an example of a user interface for adjusting internal parameters.

FIG. 25 is a diagram illustrating functional blocks for automatic optimization of internal parameters.

FIG. 26 is a flowchart describing automatic optimization processing.

FIG. 27 is a view for describing an example in which a hearing threshold of a person with hearing loss rises.

FIG. 28 is a view illustrating an example of a user interface for adjusting output parameters.

FIG. 29 is a view illustrating a display screen example of a 3D audio production/editing tool.

FIG. 30 is a view illustrating a display screen example of the 3D audio production/editing tool.

FIG. 31 is a view illustrating a display screen example of the 3D audio production/editing tool.

FIG. 32 is a view illustrating a display screen example of the 3D audio production/editing tool.

FIG. 33 is a view illustrating an example of a display change according to an operation of a slider.

FIG. 34 is a view illustrating an example of a display change according to an operation of the slider.

FIG. 35 is a diagram illustrating a configuration example of a computer.

### MODE FOR CARRYING OUT THE INVENTION

Hereinafter, an embodiment to which the present technology is applied will be described with reference to the drawings.

### First Embodiment

### <Regarding Present Technology>

The present technology relates to a method and an apparatus for automatically mixing object audio.

In the present technology, three-dimensional position information and gains of audio objects (hereinafter, also simply referred to as objects) are determined on the basis of one or a plurality of pieces of attribute information indicating a feature of each of the objects or the entire music. Therefore, it is possible to automatically create high-quality 3D audio content along a workflow of a mixing engineer.

Furthermore, according to the present technology, there are provided a user interface with which a user can adjust a behavior of an algorithm for automatic creation of 3D audio content, and a function of automatically optimizing the behavior of the algorithm according to a taste of the user. This allows many users to be satisfied and use an automatic mixing apparatus.

In particular, the present technology has the following features.

### (Feature 1)

Parameters (hereinafter, referred to as output parameters) constituting metadata of objects of content are automatically determined on the basis of one or more pieces of attribute information of each of the objects and the entire content.

### (Feature 1.1)

The content is 3D audio content.

### (Feature 1.2)

The output parameter is three-dimensional positional information or a gain of the object.

### (Feature 1.3)

The attribute information includes at least any of a “content category” indicating a type of the content, an “object category” indicating a type of the object, and an “object feature amount” which is a scalar value indicating a feature of the object. Furthermore, the content category, the object category, and the object feature amount are expressed by words that can be understood by a user, that is, characters (text information), numerical values, and the like.

### (Feature 1.3.1)

The content category is at least any of a genre, a tonality, a tempo, a feeling, a recording type, and presence or absence of a video.

### (Feature 1.3.2)

The object category is at least any of an instrument type, a reverb type, a tone type, a priority, and a role.

### (Feature 1.3.3)

The object feature amount is at least any of a rise, duration, a sound pitch, a note density, a reverb intensity, a sound pressure, a time occupancy rate, a tempo, and a Lead index.

### (Feature 1.4)

The output parameter is calculated for each of the objects by a mathematical function that uses the object feature amount as an input. Furthermore, this mathematical function may be different for each object category or content category. The output parameter may be calculated for each of the objects by the mathematical function described above, and thereafter, adjustment between the objects may be performed. Note that the mathematical function described above may be a constant function having no object feature amount as an input.

### (Feature 1.4.1)

The adjustment between the objects is adjustment of at least any of the three-dimensional position and the gain of the object.

### (Feature 1.5)

A user interface, which allows the user to select and adjust a behavior of an algorithm from candidates, is presented (displayed).

### (Feature 1.5.1)

With the user interface described above, it is possible to select or adjust a parameter of the algorithm from the candidates.

### (Feature 1.6)

Provided is a function of automatically optimizing the behavior of the algorithm on the basis of a content group designated by the user and an output parameter determined by the user for the content group.

### (Feature 1.6.1)

In the above optimization, the parameter of the algorithm is optimized.

### (Feature 1.7)

The attribute information calculated by the algorithm is presented to the user by the user interface.

### (1. Background)

For example, 3D audio can provide a new music experience in which sounds are heard from all directions at 360°, which is different from conventional 2 ch audio. In particular, in object audio which is a format of the 3D audio, various sounds can be expressed by arranging a sound source (audio object) at any position on a space.

In order to further spread the 3D audio, it is required to create a lot of pieces of high-quality content. In this regard, mixing work, that is, the work of determining a three-dimensional position and a gain of each of the objects is important. There are people called mixing engineers who specialize in the mixing work.

A general method for producing 3D audio content is to convert existing 2 ch audio content into 3D audio content. At that time, a mixing engineer receives the existing 2 ch audio data in a state of being separated for each of objects. Specifically, for example, audio data of each of the objects such as a kick object, a bass object, and a vocal object is supplied.

Next, the mixing engineer listens to the entire content or a sound of each of the objects, and analyzes a type of the content, such as a genre and a tune, and a type of each of the objects, such as an instrument type. Furthermore, the mixing engineer also analyzes any feature of a sound that each of the objects has, for example, a rise or duration.

Then, on the basis of analysis results thereof, the mixing engineer determines a position and a gain when each of the objects is arranged in a three-dimensional space. Even among objects of the same instrument type, appropriate three-dimensional position and gain change depending on features of sounds of the object, a genre of music, and the like.

The mixing work requires a high degree of experience and knowledge and time in listening to such sounds and determining the three-dimensional position and the gain based on the listening.

Depending on the scale of content, it generally takes several hours for the mixing engineer to mix one piece of content. If the mixing work can be automated, 3D audio content can be produced in a short time, which leads to further spread of 3D audio.

In this regard, the present technology provides an automatic mixing algorithm according to the workflow of the mixing engineer as described above.

That is, in the present technology, the work in which the mixing engineer listens to the entire content or a sound of each of the objects, analyzes a type of the content, a type of each of the objects, and a feature of the sound, and determines a three-dimensional position and a gain of the object on the basis of such analysis results is digitized in a range that can be expressed by a machine. Therefore, it is possible to create high-quality 3D audio content in a short time.

Furthermore, it is considered that the mixing engineer is assisted by incorporating automatic mixing into a production flow of the mixing engineer, rather than complete automation that does not require human intervention. The mixing engineer can complete mixing only by slightly adjusting a portion against his/her intention in a result obtained by the automatic mixing.

Here, there are individual differences in mixing ideas and mixing tendencies among the mixing engineers. For example, there are not only a mixing engineer who is good at mixing of pop music but also a mixing engineer who is good at mixing of hip hop music.

If genres are different, features of sounds are different even for the same instrument type, or types of instruments that appear are different in the first place. Thus, how to listen to sounds at the time of mixing varies depending on the mixing engineers. Therefore, there is a case where completely different three-dimensional positions are set in audio objects of the same music so that different musical expressions are performed.

Therefore, if there is only one behavior pattern of the automatic mixing algorithm, it is difficult for many mixing engineers to use this with satisfaction. There is a demand for a technology that allows a behavior of the algorithm to match a preference of the user.

In this regard, the present technology provides a user interface capable of adjusting the behavior of the algorithm in words that can be understood by the user, that is, capable of being customized to the user's preference, and functions for automatically optimizing the algorithm according to a taste (mixing tendency) of the user. For example, these functions are provided on a production tool.

This allows many mixing engineers to use automatic mixing without dissatisfaction. Moreover, the mixing engineers can reflect their artistic values in the algorithm through such adjustment of the behavior of the algorithm, and thus, an effect of not impairing the artistic values of the mixing engineers can also be obtained.

The present technology as described above has high affinity with the algorithm in the form conforming to the workflow of the mixing engineer as described above. This is because the algorithm is based on information expressed in words that can be understood by the mixing engineer, such as types of content and objects and features of sounds.

A disadvantage of the automatic mixing technology using general machine learning and the artificial intelligence (AI) technology is that an algorithm is black-boxed, and it is difficult for the user to adjust the algorithm itself or understand characteristics of the algorithm. On the other hand, in a technique provided by the present technology, the user can adjust an algorithm itself or understand characteristics of the algorithm.

### (2. Algorithm of Automatic Mixing)

### (2.1. Overview)

### <Configuration Example of Information Processing Apparatus>

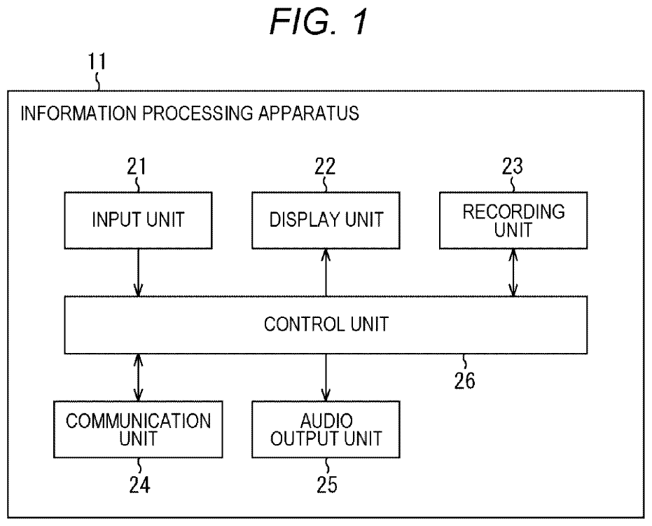

FIG. 1 is a diagram illustrating a configuration example of an information processing apparatus to which the present technology is applied.

An information processing apparatus 11 illustrated in FIG. 1 includes, for example, a computer or the like. The information processing apparatus 11 includes an input unit 21, a display unit 22, a recording unit 23, a communication unit 24, an audio output unit 25, and a control unit 26.

The input unit 21 includes, for example, an input device such as a mouse or a keyboard, and supplies a signal corresponding to an operation of a user to the control unit 26.

The display unit 22 includes a display, and displays various images (screens) such as a display screen of a 3D audio production/editing tool under control of the control unit 26. The recording unit 23 records various types of data such as audio data of each of objects and a program for implementing the 3D audio production/editing tool, and supplies the recorded data to the control unit 26 as necessary.

The communication unit 24 communicates with an external apparatus. For example, the communication unit 24 receives the audio data of each of the objects transmitted from the external apparatus and supplies the audio data to the control unit 26, and transmits data supplied from the control unit 26 to the external apparatus.

The audio output unit 25 includes a speaker and the like, and outputs a sound on the basis of the audio data supplied from the control unit 26.

The control unit 26 controls the entire operation of the information processing apparatus 11. For example, the control unit 26 executes the program for implementing the 3D audio production/editing tool recorded in the recording unit 23, thereby causing the information processing apparatus 11 to function as an automatic mixing apparatus.

### <Configuration Example of Automatic Mixing Apparatus>

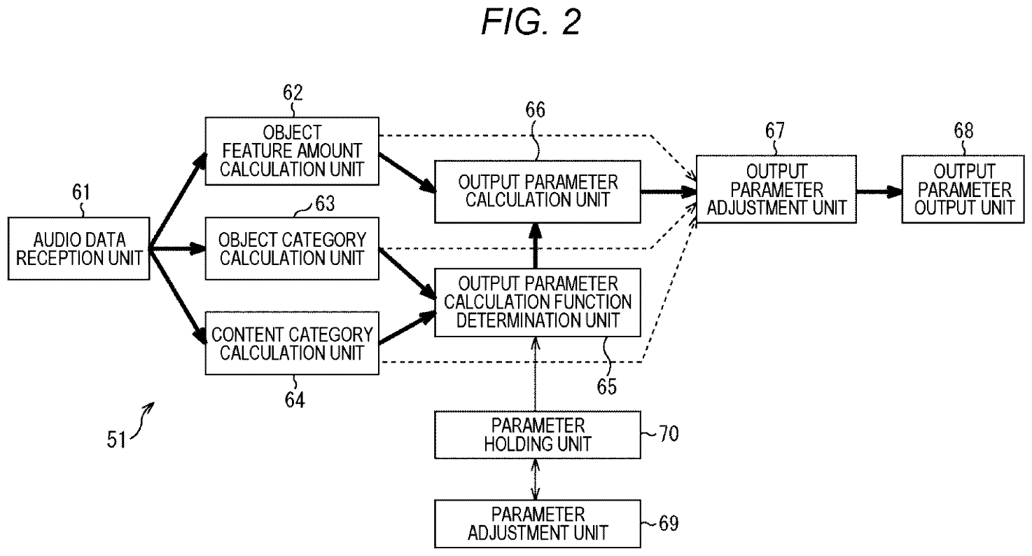

The control unit 26 executes the program, whereby an automatic mixing apparatus 51 illustrated in FIG. 2, for example, is implemented.

The automatic mixing apparatus 51 includes, as functional configurations, an audio data reception unit 61, an object feature amount calculation unit 62, an object category calculation unit 63, a content category calculation unit 64, an output parameter calculation function determination unit 65, an output parameter calculation unit 66, an output parameter adjustment unit 67, an output parameter output unit 68, a parameter adjustment unit 69, and a parameter holding unit 70.

The audio data reception unit 61 acquires audio data of each of objects and supplies the audio data to the object feature amount calculation unit 62 to the content category calculation unit 64.

The object feature amount calculation unit 62 calculates an object feature amount on the basis of the audio data from the audio data reception unit 61, and supplies the object feature amount to the output parameter calculation unit 66 and the output parameter adjustment unit 67.

The object category calculation unit 63 calculates an object category on the basis of the audio data from the audio data reception unit 61, and supplies the object category to the output parameter calculation function determination unit 65 and the output parameter adjustment unit 67.

The content category calculation unit 64 calculates a content category on the basis of the audio data from the audio data reception unit 61, and supplies the content category to the output parameter calculation function determination unit 65 and the output parameter adjustment unit 67.

The output parameter calculation function determination unit 65 determines a mathematical function (hereinafter, also referred to as an output parameter calculation function) for calculating an output parameter from the object feature amount on the basis of the object category from the object category calculation unit 63 and the content category from the content category calculation unit 64. Furthermore, the output parameter calculation function determination unit 65 reads a parameter (hereinafter, also referred to as an internal parameter) constituting the determined output parameter calculation function from the parameter holding unit 70 and supplies the parameter to the output parameter calculation unit 66.

The output parameter calculation unit 66 calculates (determines) an output parameter on the basis of the object feature amount from the object feature amount calculation unit 62 and the internal parameter from the output parameter calculation function determination unit 65, and supplies the output parameter to the output parameter adjustment unit 67.

The output parameter adjustment unit 67 adjusts the output parameter from the output parameter calculation unit 66 using the object feature amount from the object feature amount calculation unit 62, the object category from the object category calculation unit 63, and the content category from the content category calculation unit 64 as necessary, and supplies the adjusted output parameter to the output parameter output unit 68. The output parameter output unit 68 outputs the output parameter from the output parameter adjustment unit 67.

The parameter adjustment unit 69 adjusts or selects the internal parameter held in the parameter holding unit 70 on the basis of a signal supplied from the input unit 21 according to an operation of a user. Note that the parameter adjustment unit 69 may adjust or select the parameter (internal parameter) to be used for adjustment of the output parameter in the output parameter adjustment unit 67 according to a signal from the input unit 21.

The parameter holding unit 70 holds the internal parameter of the mathematical function for calculating the output parameter, and supplies the held internal parameter to the parameter adjustment unit 69 and the output parameter calculation function determination unit 65.

### <Description of Automatic Mixing Processing>

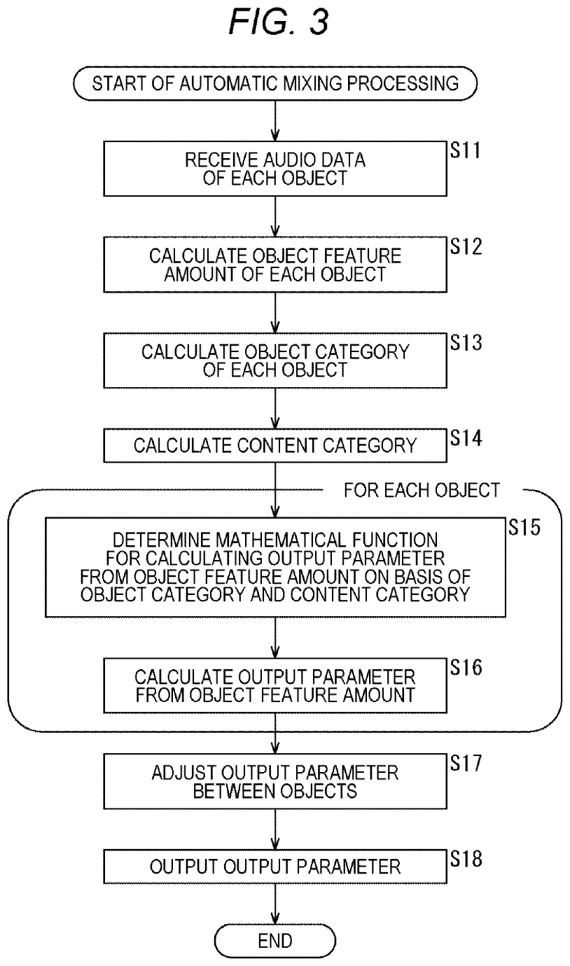

Here, automatic mixing processing by the automatic mixing apparatus 51 will be described with reference to a flowchart illustrated in FIG. 3.

In step S11, the audio data reception unit 61 receives audio data of each of objects of 3D audio content input to the automatic mixing apparatus 51, and supplies the audio data to the object feature amount calculation unit 62 to the content category calculation unit 64. For example, the audio data of each of the objects is input from the recording unit 23, the communication unit 24, and the like.

In step S12, the object feature amount calculation unit 62 calculates an object feature amount that is a scalar value indicating a feature of each of the objects on the basis of the audio data of each of the objects supplied from the audio data reception unit 61, and supplies the object feature amount to the output parameter calculation unit 66 and the output parameter adjustment unit 67.

In step S13, the object category calculation unit 63 calculates an object category indicating a type of each of the objects on the basis of the audio data of each of the objects supplied from the audio data reception unit 61, and supplies the object category to the output parameter calculation function determination unit 65 and the output parameter adjustment unit 67.

In step S14, the content category calculation unit 64 calculates a content category indicating a type of music (content) on the basis of the audio data of each of the objects supplied from the audio data reception unit 61, and supplies the content category to the output parameter calculation function determination unit 65 and the output parameter adjustment unit 67.

In step S15, the output parameter calculation function determination unit 65 determines a mathematical function for calculating an output parameter from the object feature amounts on the basis of the object category supplied from the object category calculation unit 63 and the content category supplied from the content category calculation unit 64. Note that at least any one of the object category or the content category may be used to determine the mathematical function.

Furthermore, the output parameter calculation function determination unit 65 reads an internal parameter of the determined output parameter calculation function from the parameter holding unit 70 and supplies the internal parameter to the output parameter calculation unit 66. For example, in step S15, an output parameter calculation function is determined for each of the objects.

The output parameter here is at least any of three-dimensional position information indicating a position of an object in a three-dimensional space and a gain of audio data of the object. As an example, the three-dimensional position information is, for example, polar coordinates indicating a position of the object in a polar coordinate system including an azimuth angle “azimuth” indicating a position of the object in the horizontal direction, an elevation angle “elevation” indicating a position of the object in the vertical direction, and the like.

In step S16, the output parameter calculation unit 66 calculates (determines) an output parameter on the basis of the object feature amount supplied from the object feature amount calculation unit 62 and the output parameter calculation function determined by the internal parameter supplied from the output parameter calculation function determination unit 65, and supplies the output parameter to the output parameter adjustment unit 67. The output parameter is calculated for each of the objects.

In step S17, the output parameter adjustment unit 67 performs adjustment of the output parameters supplied from the output parameter calculation unit 66 between the objects, and supplies the adjusted output parameter of each of the objects to the output parameter output unit 68.

That is, the output parameter adjustment unit 67 adjusts output parameters of one or more objects on the basis of output parameter determination results on the basis of the output parameter calculation function obtained for the plurality of objects.

At this time, the output parameter adjustment unit 67 appropriately adjusts the output parameter using the object feature amount, the object category, and the content category.

The object feature amount, the object category, and the content category are attribute information indicating an attribute of content or the object. Therefore, it can be said that processing performed in the above steps S15 to S17 is processing of determining (calculating) the output parameter forming metadata of the object on the basis of one or a plurality of pieces of the attribute information.

In step S18, the output parameter output unit 68 outputs the output parameter of each of the objects supplied from the output parameter adjustment unit 67, and the automatic mixing processing ends.

As described above, the automatic mixing apparatus 51 calculates the object feature amount, the object category, and the content category, which are the attribute information, and calculates (determines) the output parameter on the basis of the attribute information.

In this manner, it is possible to create high-quality 3D audio content in a short time according to a workflow of a mixing engineer in consideration of features of the objects and the entire music. Note that the automatic mixing processing described with reference to FIG. 3 may be performed on music, that is, the entire content (3D audio content), or may be performed on a partial time section of the content for each time section.

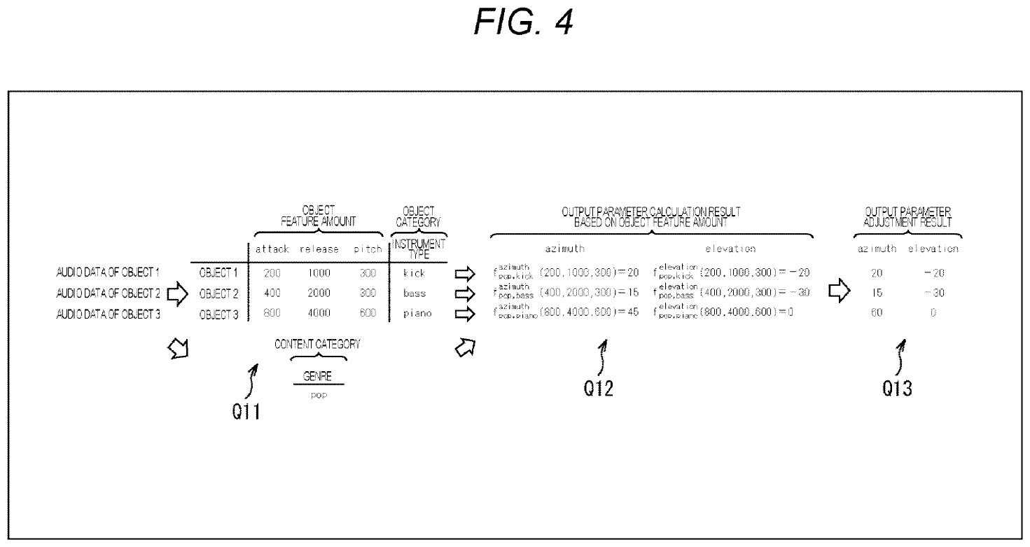

Here, a specific example of output parameter calculation will be described with reference to FIG. 4.

In the example illustrated in FIG. 4, as illustrated on the left side in the drawing, pieces of audio data of three objects of Objects 1 to 3 are input, and an azimuth angle “azimuth” and an elevation angle “elevation” as three-dimensional position information are output as output parameters of each of the objects.

First, as indicated by an arrow Q11, three types of object feature amounts of a rise “attack”, duration “release”, and a sound pitch “pitch” are calculated from pieces of the audio data for Objects 1 to 3. Furthermore, an “instrument type” is calculated as an object category for each of the objects, and a “genre” is calculated as a content category.

Next, as indicated by an arrow Q12, output parameters are calculated from the object feature amounts for each of the objects.

Here, a mathematical function (output parameter calculation function) for calculating an output parameter from the object feature amount is prepared for each combination of a music genre and an instrument type.

For example, for Object 1, since the music genre is “pop” and the instrument type is “kick”, the azimuth angle “azimuth” is calculated using a mathematical function f_{pop,kick}^{azimuth}.

Regarding other output parameters, a mathematical function prepared for each combination of a music genre and an instrument type is used, and output parameters are calculated from object feature amounts. As a result, output parameters of each of the objects indicated by the arrow Q12 are obtained.

Finally, output parameter adjustment is performed, and as a result, final output parameters are obtained as indicated by an arrow Q13.

Next, the respective units of the automatic mixing apparatus 51 and outputs of the respective units will be described more specifically.

### (2.2. Attribute Information of Object and Music Used for Output Parameter Determination)

The “attribute information” used for output parameter determination is divided into a “content category” indicating a type of music, an “object category” indicating a type of an object, and an “object feature amount” that is a scalar value indicating a feature of the object.

### (2.2.1. Content Category)

The content category is information indicating a type of content, and is expressed (represented) by, for example, characters that can be understood by a user. Examples of the content category in a case where content is music include a genre, tempo, a tonality, a feeling, a recording type, the presence or absence of a video, and the like. Details thereof are described below.

Note that the content category may be automatically obtained from object data, or may be manually input by the user. In a case where the content category calculation unit 64 automatically obtains a content category, the content category may be estimated from audio data of an object by a classification model trained using a machine learning technology, or may be determined on the basis of rule-based signal processing.

### (Genre)

The genre is a type of a song classified according to a rhythm of the song, a musical scale to be used, and the like. Examples of the genre of music include rock, classical music, electronic dance music (EDM), and the like

### (Tempo)

The tempo is obtained by classifying music according to a sense of speed of the music. Examples of the tempo of music include fast, middle, slow, and the like.

### (Tonality)

The tonality indicates a fundamental tone and a musical scale of music. Examples of the tonality of music include A Minor and D Major.

### (Feeling)

The feeling is obtained by classifying music according to the atmosphere of the music or a feeling felt by a listener. Examples of the feeling of music include happy, cool, and melodic.

### (Recording Type)

The recording type indicates a type of recording of audio data. Examples of the recording type of the music include live, studio, and programming.

### (Presence or Absence of Video)

The presence or absence of a video indicates the presence or absence of video data synchronized with audio data as content. For example, it is indicated as “0” in a case where there is video data.

### (2.2.2. Object Category)

The object category is information indicating a type of an object, and is expressed (indicated) by, for example, characters that can be understood by a user. Examples of the object category include an instrument type, a reverb type, a tone type, a priority, a role, and the like. Details thereof are described below.

Note that the object category may be automatically obtained from the audio data of the object, or may be manually input by the user. In a case where the object category calculation unit 63 automatically obtains the object category, the content category may be estimated from audio data of an object by a classification model trained using a machine learning technology, or may be determined on the basis of rule-based signal processing. Furthermore, in a case where a name of an object includes a character string related to an object category, the object category may be extracted from text information indicating the name of the object.

### (Instrument Type)

The instrument type indicates a type of an instrument recorded in audio data of each object. For example, an object in which a violin sound is recorded is categorized as “strings”, and an object in which a singing voice of a person is recorded is categorized as “vocal”.

Examples of the instrument type may include “bass”, “synthBass”, “kick”, “snare”, “rim”, “hat”, “tom”, “crash”, “cymbal”, “clap”, “perc”, “drums”, “piano”, “guitar”, “keyboard”, “synth”, “organ”, “brass”, “synthBrass”, “strings”, “orch”, “pad”, “vocal”, “chorus”, and the like.

### (Reverb Type)

The reverb type is obtained by roughly dividing a reverb intensity as an object feature amount to be described later for each intensity. For example, Dry, ShortReverb, MidReverb, LongReverb, and the like are set in ascending order of the reverb intensity.

### (Tone Type)

The tone type is obtained by classifying which effect and feature a tone of audio data of each object has. For example, an object having a tone used as a sound effect in a song is classified as “fx”, and a case where a sound is distorted by signal processing is classified as “dist”. Examples of the tone type may include “natural”, “fx”, “accent”, “robot”, “loop”, “dist”, and the like.

### (Priority)

The priority indicates the importance of an object in music. For example, a vocal is an object that is indispensable in a lot of pieces of content, and a high priority is set. The priority is indicated in seven stages of 1 to 7, for example. As the priority, an eigenvalue set in advance by each mixing engineer at a content production stage may be held, the priority may be arbitrarily changeable, or the priority may be dynamically changeable in a system (the content category calculation unit 64 or the like) according to an instrument type or a content type.

### (Role)

The role is obtained by roughly dividing a role of an object in music. Examples of the “role” may include “Lead” indicating an object that plays an important role in music such as a main vocal playing a main melody or a main accompaniment instrument and “Not Lead” indicating an object different therefrom (that does not play an important role).

Furthermore, as a more detailed “role”, there may be “double” that plays a role of thickening a sound by superimposing the same sound on a main melody, “harmony” that plays a role of harmony, “space” that plays a role of expressing a spatial extent of a sound, “obbligato” that plays a role of a counter melody, “rhythm” that plays a role of expressing a rhythm of a song, and the like.

For example, in a case where whether the “role” is “Lead” or “Not Lead” is to be obtained, the “role” may be calculated on the basis of a sound pressure or a time occupancy rate of each object (audio data of the object). This is because an object having a high sound pressure or an object having a high time occupancy rate is considered to play an important role in music.

Furthermore, even if the sound pressure and the time occupancy rate are the same, a result of determination of the “role” may be different depending on an instrument type. This is because a characteristic of every instrument, such as that a piano or a guitar generally plays an important role in music and a pad hardly plays an important role, is reflected.

Moreover, an instrument type, a sound pitch, a priority, and the like may also be used at the time of calculating the “role”, in addition to the sound pressure and the time occupancy rate. In particular, in a case where more detailed classification such as “double” is performed as the “role”, the “role” can be appropriately obtained by using the instrument type, the sound pitch, the priority, and the like.

### (2.2.3. Object Feature Amount)

The object feature amount is a scalar value indicating a feature of an object. For example, the object feature amount is expressed by a numerical value that can be understood by a user. Examples thereof include a rise, duration, a sound pitch, a note density, a reverb intensity, a sound pressure, a time occupancy rate, a tempo, a Lead index, and the like. Details thereof and an example of a calculation method are described below.

Note that, in addition to the method described below, the object feature amount calculation unit 62 may estimate the object feature amount from audio data by a regression model trained using a machine learning technology, or may extract the object feature amount from a name of an object. Furthermore, the user may manually input the object feature amount.

Furthermore, the object feature amount may be calculated from the entire audio data, or may be calculated by detecting one sound or one phrase by a known method and aggregating values of feature amounts calculated for each detected sound and each phrase by a known method.

### (Rise)

The rise is a time until a certain volume is reached since a certain sound starts to be generated. For example, it is sensed that a sound has been generated at the moment of clapping in a handclap, and thus, the rise is short, and a small value is taken as a feature amount. On the other hand, it takes more time from the start of flicking until the user feels that the sound has been generated, a violin has a longer rise and takes a larger value as a feature amount than the handclap.

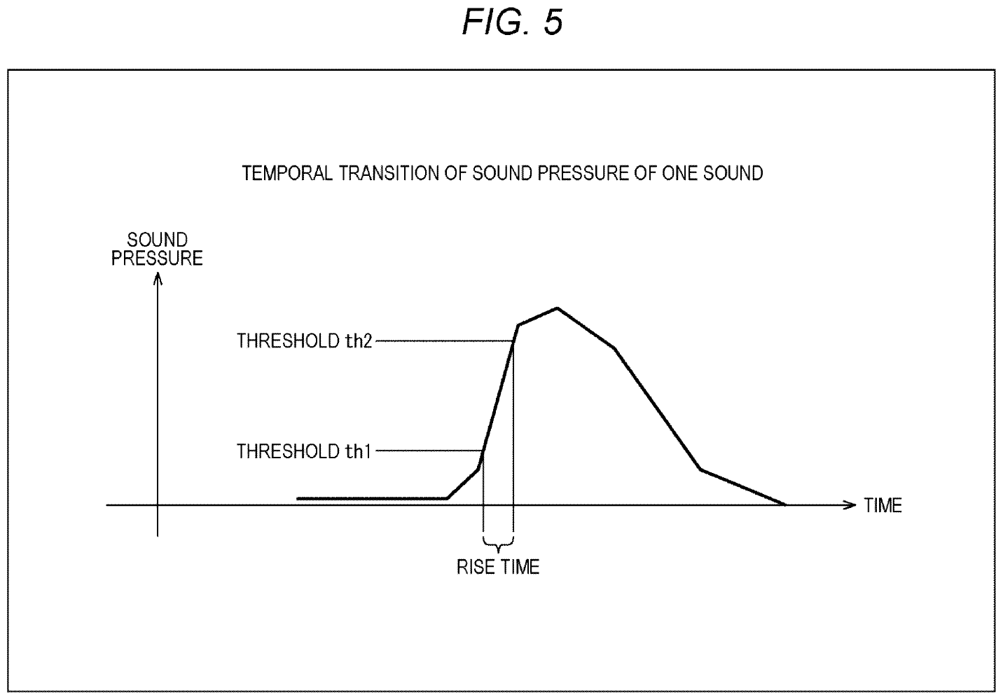

As a calculation method of the rise, for example, as illustrated in FIG. 5, a volume (sound pressure) of a certain sound for each time can be examined, and a time until the volume reaching a small threshold th1 reaches a large threshold th2 can be set as the rise. Note that, in FIG. 5, the horizontal axis represents time, and the vertical axis represents the sound pressure.

The audio data may be processed to calculate a reasonable volume. Furthermore, the threshold th1 and the threshold th2 may be values relatively determined from values obtained from the audio data as a target for which the rise is calculated, or may be absolute values determined in advance. The unit of the feature amount of the rise is not necessarily time, and may be the number of samples or the number of frames.

As a specific example, for example, the object feature amount calculation unit 62 first applies a band-limiting filter to the audio data (performs filtering). The band-limiting filter is a low-pass filter that passes 4000 Hz or less.

The object feature amount calculation unit 62 cuts out one sound from the audio data to which the filter has been applied, and obtains a sound pressure (dB) for each processing section while shifting a processing section of a predetermined length by a predetermined time. The sound pressure in the processing section can be obtained by the following Formula (1).

$$\begin{matrix}[ Math . 1 ] & \\ Sound pressure in processing section = 10 {log}_{10} ( \frac{{xx}^{T}}{{n}_{x}} ) \\ x : row vector of audio data in processing section \\ {n}_{x} : number of elements of x & ( 1 )\end{matrix}$$

Note that, in Formula (1), x represents a row vector of the audio data in the processing section, and nx represents the number of elements of the row vector x.

The object feature amount calculation unit 62 sets, as the feature amount of the rise of one sound, the number of samples from when the sound pressure for each processing section reaches the threshold th1 set for a maximum value of the sound pressure for each processing section within the one sound to when the sound pressure reaches the threshold th2 set for the maximum value.

### (Duration)

The duration is a time until a sound reaches a certain volume or less since the rise. For example, a sound disappears immediately after the sound is generated in a handclap, the duration is short, and a small value is taken as a feature amount. On the other hand, since it takes more time from when a sound is generated to when the sound disappears in a violin as compared with the handclap, the duration is long and a large value is taken as a feature amount.

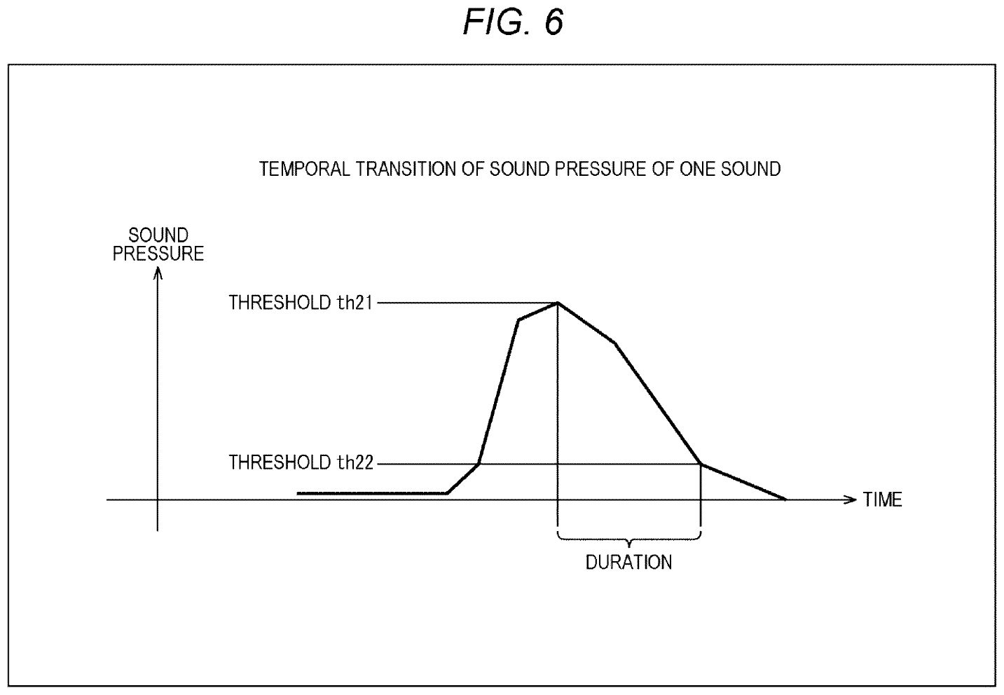

As a calculation method of the duration, for example, as illustrated in FIG. 6, a volume (sound pressure) of a certain sound for each time can be examined, and a time until the volume reaching a large threshold th2l reaches a small threshold th22 can be set as the duration. Note that, in FIG. 6, the horizontal axis represents time, and the vertical axis represents the sound pressure.

The audio data may be processed to calculate a reasonable volume. Furthermore, the threshold th2l and the threshold th22 may be values relatively determined from values obtained from the audio data as a target for which the duration is calculated, or may be absolute values determined in advance. The unit of the feature amount of the duration is not necessarily time, and may be the number of samples or the number of frames.

As a specific example, for example, the object feature amount calculation unit 62 first applies a band-limiting filter to the audio data. The band-limiting filter is a low-pass filter that passes 4000 Hz or less.

Next, the object feature amount calculation unit 62 cuts out one sound from the audio data to which the filter has been applied, and obtains a sound pressure (dB) for each processing section while shifting a processing section of a predetermined length by a predetermined time. A calculation formula of the sound pressure in the processing section is the same as Formula (1).

The object feature amount calculation unit 62 sets, as the feature amount of the duration of one sound, the number of samples from when the sound pressure for each processing section reaches the threshold th2l, which is a maximum value of the sound pressure for each processing section within the one sound, to when the sound pressure reaches the threshold th22 set for the maximum value.

### (Sound Pitch)

Regarding the sound pitch, for example, a sound of an instrument in charge of low-pitched sounds such as a bass takes a low value as a feature amount, and a sound of an instrument in charge of high-pitched sounds such as a flute takes a high value as a feature amount.

As a calculation method of the sound pitch, for example, there is a method of using a zero-crossing rate as a feature amount. The zero-crossing rate is a feature amount that can be understood as a sound pitch and is expressed by a scalar value from 0 to 1.

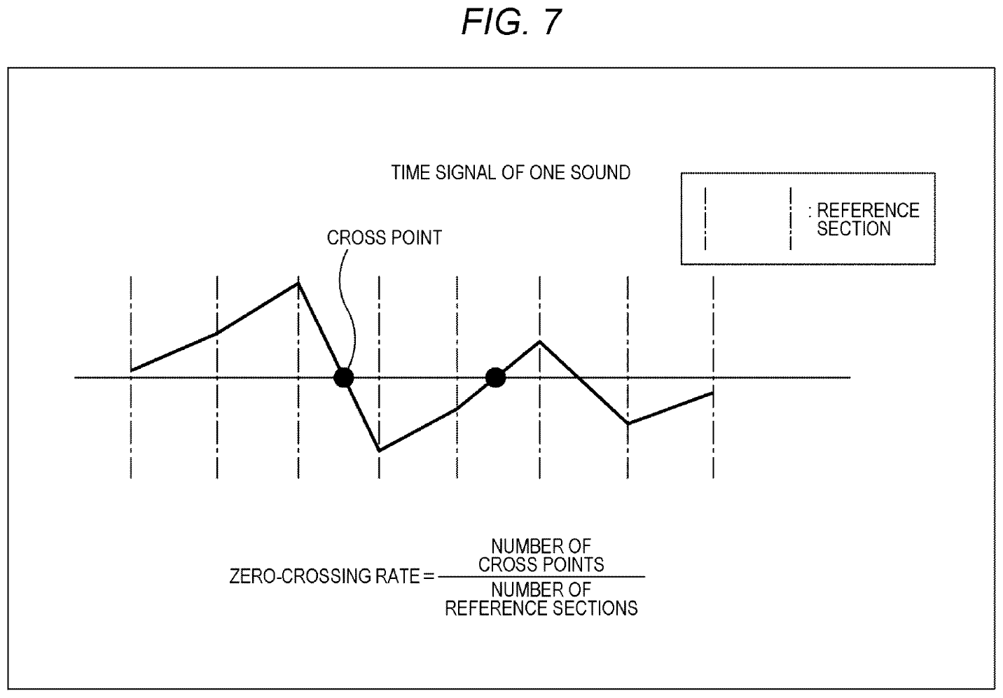

For example, as illustrated in FIG. 7, in audio data (a time signal) of a certain sound, a point at which signs of signal values are switched between before and after can be set as a cross point, and a value obtained by dividing the number of cross points by the number of referred samples can be set as the zero-crossing rate.

Note that, in FIG. 7, the horizontal axis represents time, and the vertical axis represents a value of the audio data. In FIG. 7, one circle indicates a cross point. In particular, a position where the audio data indicated by a polygonal line intersects with a horizontal line in the drawing is the cross point.

The audio data may be processed to calculate a reasonable zero-crossing rate. As a condition for the cross point, a condition other than “the signs are switched” may be added. Furthermore, the sound pitch may be calculated from a frequency domain and used as an object feature amount.

As a specific example, for example, the object feature amount calculation unit 62 first applies a band-limiting filter to the audio data. The band-limiting filter is a low-pass filter that passes 4000 Hz or less.

The object feature amount calculation unit 62 cuts out one sound from the audio data to which the filter has been applied, and calculates the zero-crossing rate) for each processing section while shifting a processing section of a predetermined length by a predetermined time.

As a condition of the cross point, a positive threshold th31 and a negative threshold th32 (not illustrated) are given, and a case where a value changes from the threshold th31 or more to the threshold th32 or less on the time signal and a case where a value changes from the threshold th32 or less to the threshold th31 or more are set as the cross points. The object feature amount calculation unit 62 obtains the zero-crossing rate for each processing section by dividing the number of the cross points by a length of the processing section. The object feature amount calculation unit 62 sets, as the feature amount of the zero-crossing rate of one sound, an average of the zero-crossing rates for each processing section calculated within the one sound.

The audio data may be processed to calculate a reasonable volume. Furthermore, the threshold th31 and the threshold th32 may be values relatively determined from values obtained from the audio data as a target for which the sound pitch is calculated, or may be absolute values determined in advance. The unit of the feature amount of the sound pitch is not necessarily time, and may be the number of samples or the number of frames.

### (Note Density)

The note density is a time density of the number of sounds in the audio data. For example, in a case where one sound is very short and the number of sounds is large, the time density of the number of sounds becomes high, and thus, the note density takes a high value. On the other hand, in a case where one sound is very long and the number of sounds is small, the time density of the number of sounds is low, and thus, the note density takes a low value.

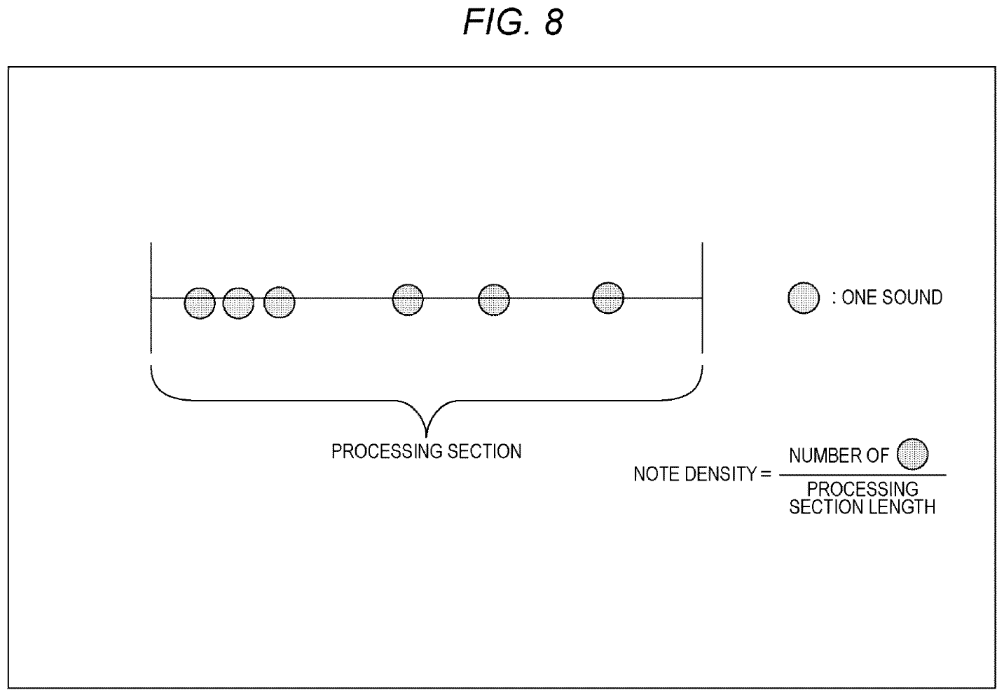

As a calculation method of the note density, for example, as illustrated in FIG. 8, the note density can be obtained by first acquiring sound generation positions and the number of sounds from the audio data and dividing the number of generated sounds by a time of a section in which the sounds are generated. Note that, in FIG. 8, the horizontal direction represents time, and one circle indicates one sound generation position (one sound).

Note that the note density may be calculated as the number of generated sounds per measure using a feature amount of the tempo as described later. Furthermore, an average value of the note densities in the respective processing sections may be used as the feature amount (object feature amount), or a maximum value or a minimum value of a local note density may be used as the feature amount.

As a specific example, for example, the object feature amount calculation unit 62 first calculates a site where a sound is generated on the basis of the audio data. Next, the object feature amount calculation unit 62 counts the number of sounds in a processing section while shifting the processing section of a predetermined length from the head of the audio data by a predetermined time, and divides the number of sounds by a time of one processing section.

For example, the object feature amount calculation unit 62 counts the number of sounds generated in two seconds and divides the number of sounds by two seconds, thereby calculating a note density in one second. The object feature amount calculation unit 62 performs these processes up to the end (termination) of the audio data and obtains an average of note densities of every processing section in which the number of sounds is not zero as the note density of the audio data.

### (Reverb Intensity)

The reverb intensity indicates the degree of reverberation, and is a feature amount that can be understood as a length of a sound echo. For example, when hands are clapped in a futon, there is no echo and only a sound of a handclap is heard, so that the sound has a weak reverb intensity. On the other hand, when hands are clapped in a space such as a church, an echo remains together with a plurality of reflected sounds, and thus, a sound with a high reverb intensity is generated.

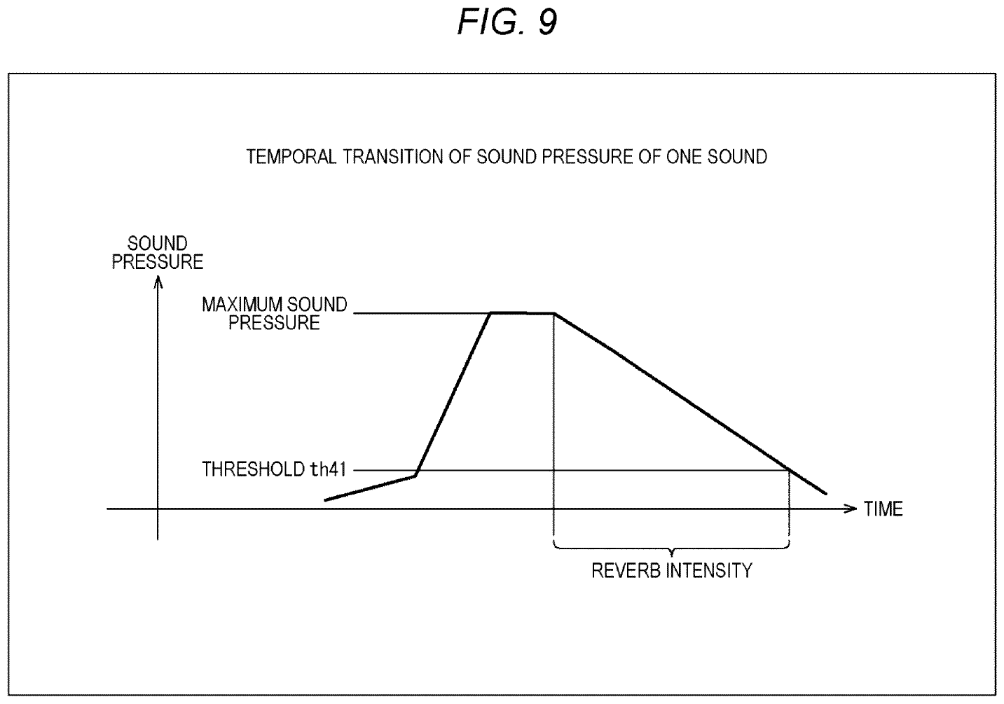

As a calculation method of the reverb intensity, for example, as illustrated in FIG. 9, a time until a sound pressure reaching a maximum sound pressure reaches a small threshold th41 or less for a certain sound can be set as the reverb intensity. Note that, in FIG. 9, the horizontal axis represents time, and the vertical axis represents the sound pressure.

For example, a time until the sound pressure of the audio data decreases by 60 dB from the maximum sound pressure may be set as the reverb intensity. Furthermore, not only the calculation in a time domain but also sound pressure calculation in a frequency domain may be performed, and a reduction time to the threshold th41 of the sound pressure in a predetermined frequency range may be set as the reverb intensity.

The audio data may be processed to calculate a reasonable volume. Furthermore, the threshold th41 may be a value relatively determined from a value obtained from the audio data as a target for which the reverb intensity is calculated, or may be an absolute value determined in advance. The unit of the feature amount of the reverb intensity is not necessarily time, and may be the number of samples or the number of frames. Furthermore, the threshold th41 may be individually or dynamically set according to initial reflection, a late reverberation sound, and a reproduction environment.

### (Sound Pressure)

The sound pressure is a feature amount that can be understood as the magnitude of a sound. The sound pressure represented as the object feature amount may be a maximum sound pressure value or a minimum sound pressure value in the audio data. Furthermore, a target for which the sound pressure is calculated may be set for each predetermined number of seconds, or the sound pressure may be calculated for each phrase, for each sound, or for each range that can be divided from a musical viewpoint.

For example, the sound pressure can be calculated by using Formula (1) for audio data in a predetermined section.

As a specific example, for example, the object feature amount calculation unit 62 first calculates a sound pressure in a processing section while shifting the processing section of a predetermined length from the head of the audio data by a predetermined time. The object feature amount calculation unit 62 calculates the sound pressures in all the sections of the audio data, and sets a maximum sound pressure among all the sound pressures as the feature amount (object feature amount) of the sound pressure.

### (Time Occupancy Rate)

The time occupancy rate is a ratio of a sound generation time to a sound source time. For example, singing (generating sounds) for a long time through music, such as a vocal, has a high time occupancy rate. On the other hand, a percussion instrument or the like that generates only one sound in music has a low time occupancy rate.

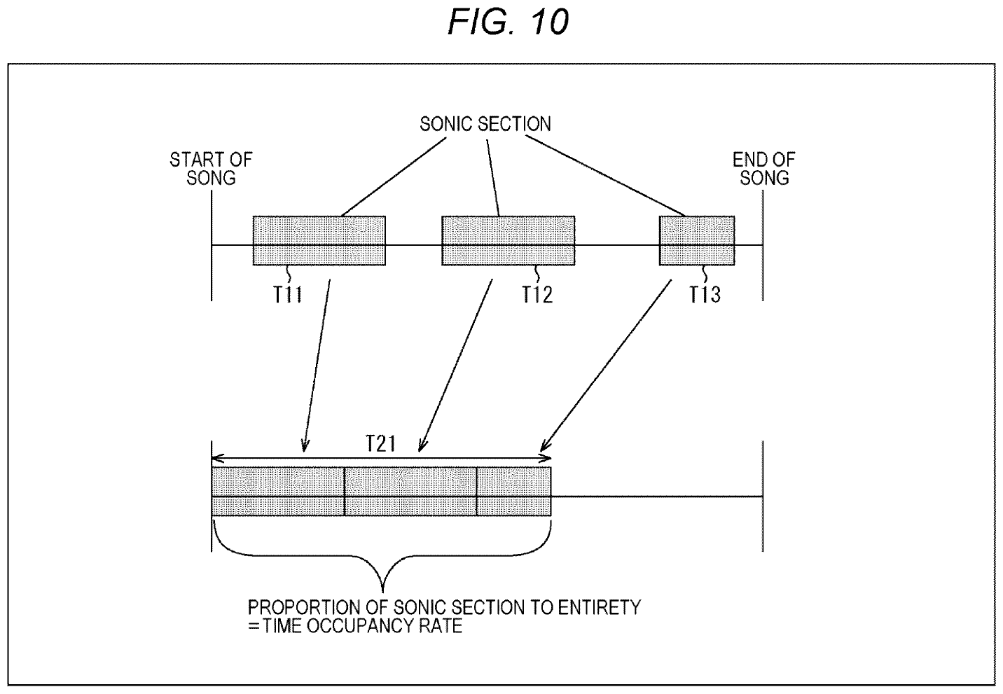

As a calculation method of the time occupancy rate, for example, as illustrated in FIG. 10, the calculation is possible by dividing a sound generation time by a sound source time.

In FIG. 10, a section T11 to a section T13 indicate sonic sections for a predetermined object, and a time occupancy rate can be obtained by dividing a length (time) of a section T21, obtained by adding these sections T11 to T13, by a length of time of the entire audio data.

Note that the time occupancy rate may be calculated by considering even a sound generation time in which a sound is interrupted for a short period of time as a section in which the sound is also generated during the short period of time and using the short period of time during which the sound is interrupted as a time related to performance.

As a specific example, for example, the object feature amount calculation unit 62 first calculates a length of a site where a sound is generated from the audio data, that is, each of sections including sounds of objects. Then, the object feature amount calculation unit 62 calculates a sum of times of the respective sections obtained by the calculation as a sonic time, and calculates the feature amount (object feature amount) of the time occupancy rate of the object by dividing the sonic time by a total time of music.

### (Tempo)

The tempo is a feature amount of a speed of music. In general, the number of beats present per minute is defined as the tempo.

As a calculation method of the tempo, it is common to calculate autocorrelation and convert a value of a delay amount having a high correlation. Note that the value of the delay amount or a reciprocal of the delay amount may be directly used as the feature amount of the tempo without being converted into the number of beats per minute.

As a specific example, for example, the object feature amount calculation unit 62 first uses audio data of a rhythm instrument as a target. Note that whether or not an instrument is the rhythm instrument may be determined using a known determination algorithm or may be acquired from an instrument type (category information) of the object category.

The object feature amount calculation unit 62 cuts out a section with a sound for a predetermined number of seconds from the audio data of the rhythm instrument to obtain an envelope. Then, the object feature amount calculation unit 62 performs autocorrelation with respect to the envelope, and sets a reciprocal of a delay amount having a high correlation as the feature amount (object feature amount) of the tempo.

### (Lead Index)

The Lead index is a feature amount indicating relative importance of an object in music. For example, an object of a main vocal or a main accompaniment instrument that plays a main melody has a high Lead index, and an object that plays a role of harmony for the main melody has a low Lead index.

The Lead index may be calculated on the basis of a sound pressure or a time occupancy rate of each object. This is because an object having a high sound pressure or an object having a high time occupancy rate is considered to play an important role in music.

Furthermore, even if the sound pressure and the time occupancy rate are the same, the Lead Index may be different depending on an instrument type. This is because a characteristic of every instrument, such as that a piano or a guitar generally plays an important role in music and a pad hardly plays an important role, is reflected. In addition to the sound pressure and the time occupancy rate, other information such as an instrument type, a sound pitch, and a priority may be used to calculate the Lead index.

(2.3. Mathematical Function for Calculating Output Parameter from Object Feature Amount)

The output parameter is calculated for each object by a mathematical function (output parameter calculation function) that uses an object feature amount as an input.

Note that the output parameter calculation function may be different for each object category, may be different for each content category, or may be different for each combination of an object category and a content category.

The mathematical function for calculating the output parameter from object feature amounts includes, for example, the following three portions FXP1 to FXP3.

(FXP1): A selection portion that selects object feature amounts used for output parameter calculation

(FXP2): A combining portion that combines the object feature amounts selected in the selection portion FXP1 into one value

(FXP3): A conversion portion that converts the one value obtained in the combining portion FXP2 into an output parameter

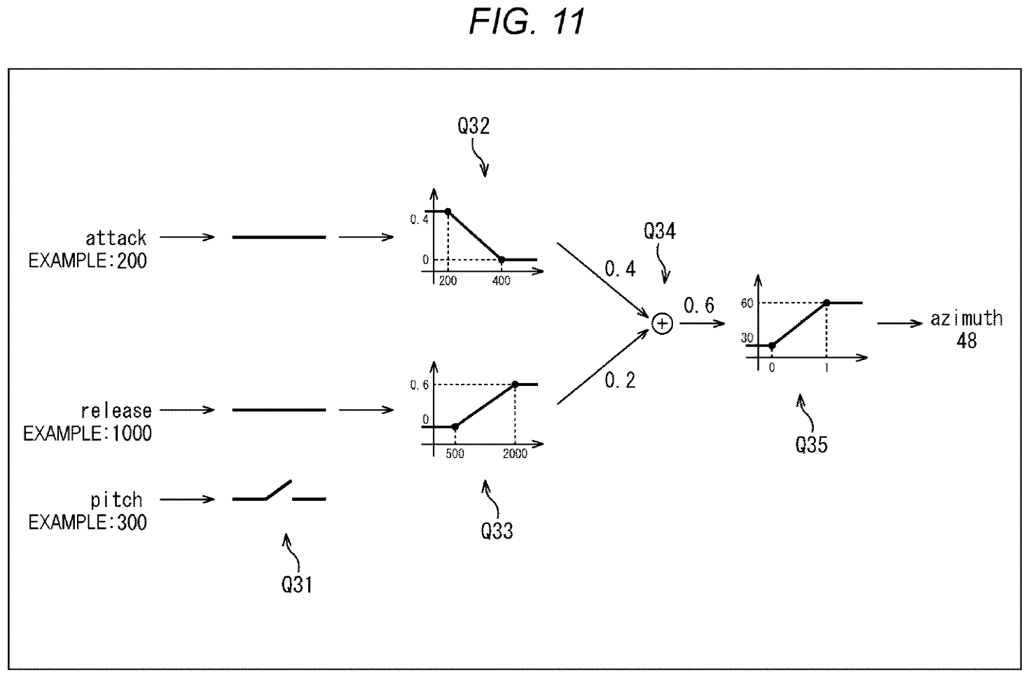

Here, an example of a mathematical function for calculating the azimuth angle “azimuth” as the output parameter from three object feature amounts of the rise “attack”, the duration “release”, and the sound pitch “pitch” is illustrated in FIG. 11.

In this example, “200” is input as a value of the rise “attack”, “1000” is input as a value of the duration “release”, and “300” is input as a value of the sound pitch.

First, as indicated by an arrow Q31, the rise “attack” and the duration “release” are selected as object feature amounts used to calculate the azimuth angle “azimuth”. A portion indicated by the arrow Q31 is the above-described selection portion FXP1.

Next, in portions indicated by arrows Q32 to Q34, the value of the rise “attack” and the value of the duration “release” are combined into one value.

Specifically, in graphs on a two-dimensional plane indicated by the arrow Q32 and the arrow Q33, respectively, the horizontal axis represents a value of the object feature amount, and the vertical axis represents a value after conversion.

The value “200” of the rise “attack” input as the object feature amount is converted into a value “0.4” by the graph (conversion function) indicated by the arrow Q32. Similarly, the value “1000” of the duration “release” input as the object feature amount is converted into a value “0.2” by the graph (conversion function) indicated by the arrow Q33.

Then, the two values “0.4” and “0.2” thus obtained are summed (combined) as indicated by the arrow Q34 to obtain one value of “0.6”. The portions indicated by the arrows Q32 to Q34 correspond to the above-described combining portion FXP2.

Finally, as indicated by an arrow Q35, the value “0.6” obtained in the portions indicated by the arrows Q32 to Q34 is converted into a value “48” of the azimuth angle “azimuth” as the output parameter.

In a graph (conversion function) on the two-dimensional plane indicated by the arrow Q35, the horizontal axis represents a result of combining the object feature amounts into one value, that is, a value of the object feature amount after combination, and the vertical axis represents a value of the azimuth angle “azimuth” output as the output parameter. A portion indicated by the arrow Q35 is the above-described conversion portion FXP3.

Note that the graphs for conversion in the portion indicated by the arrow Q32, the portion indicated by the arrow Q33, and the portion indicated by the arrow Q35 may have any shape. However, when the shapes of these graphs are limited to appropriately obtain parameters, it is possible to facilitate adjustment of a behavior of the algorithm for implementing automatic mixing, that is, adjustment of internal parameters.

For example, as indicated by the arrows Q32, Q33, and Q35 in FIG. 11, the input/output relationship of the graph may be defined by two points, and a value between the two points may be obtained by linear interpolation. In such a case, coordinates and the like of the points for designating the shape of the graph are set as internal parameters that constitute the output parameter calculation function and are changeable (adjustable) by the user.

For example, in the portion indicated by the arrow Q32, two points of (200, 0.4) and (400, 0) in the graph are designated. In this manner, the input/output relationship of the graph can be variously changed only by changing the coordinates of the two points. Note that there may be any number of points that prescribes the input/output relationship. Furthermore, a method for the interpolation between designated points is not limited to the linear interpolation, and may be a known interpolation method such as spline interpolation.

Moreover, a method of simply controlling a graph shape with fewer internal parameters is conceivable. For example, a contribution range of each object feature amount to the output parameter may be obtained as an internal parameter for adjusting the behavior of the algorithm based on the output parameter calculation function. The contribution range is a range of values of an object feature amount in which, when the object feature amount changes, the output parameter changes accordingly.

For example, in the portion indicated by the arrow Q32 in FIG. 11, the azimuth angle “azimuth”, which is the output parameter, is affected by the rise “attack”, which is the object feature amount, in a range in which the value of the rise “attack” is from “200” to “400”. That is, the range from “200” to “400” is the contribution range of the rise “attack”.

In this regard, the values “200” and “400” of the rise “attack” can be used as internal parameters (internal parameters of the output parameter calculation function) for adjusting the behavior of the algorithm.

Furthermore, a contribution degree of each object feature amount may be used as an internal parameter. The contribution degree is a degree of contribution of an object feature amount to the output parameter, that is, a weight for each object feature amount.

For example, in the example of FIG. 11, the rise “attack” as the object feature amount is converted into a value of 0 to 0.4, and the duration “release” as the object feature amount is converted into a value of 0 to 0.6. In this regard, a contribution degree of the rise “attack” can be set as 0.4, and a contribution degree of the duration “release” can be set as 0.6.

Moreover, a change range of the output parameter may be an internal parameter for adjusting the behavior of the algorithm based on the output parameter calculation function.

For example, in the example of FIG. 11, values in a range of 30 to 60 are output as the azimuth angle “azimuth”, these “30” and “60” can be used as internal parameters.

Note that the mathematical function for calculating the output parameter from the object feature amounts is not a form that has been described so far, and may be a mathematical function that performs simple linear combination, multilayer perceptron, or the like.

Furthermore, how to hold the internal parameter of the mathematical function for calculating the output parameter from the object feature amounts may be changed according to a calculation resource of an environment in which the automatic mixing is performed.

For example, in a case where 3D audio production is performed in an environment with a strong memory capacity constraint such as a mobile device, the automatic mixing can be performed without any pressure on a memory by adopting a simple graph shape control method as described with reference to FIG. 11.

The mathematical function for calculating the output parameter from the object feature amounts may be different for each object category or content category.

For example, an object feature amount to be used, a contribution range and a contribution degree of the object feature amount, a change range of the output parameter, and the like can be changed between a case where the instrument type is “kick” and a case where the instrument type is “bass”. In this manner, it is possible to perform appropriate output parameter calculation in consideration of a property for each instrument type.

Furthermore, the contribution range, the contribution degree, the change range of the output parameter, and the like may be similarly changed, for example, between cases of “pop” and “R&B” as the genre of music. In this manner, it is possible to perform appropriate output parameter calculation in consideration of a property for each genre of music.

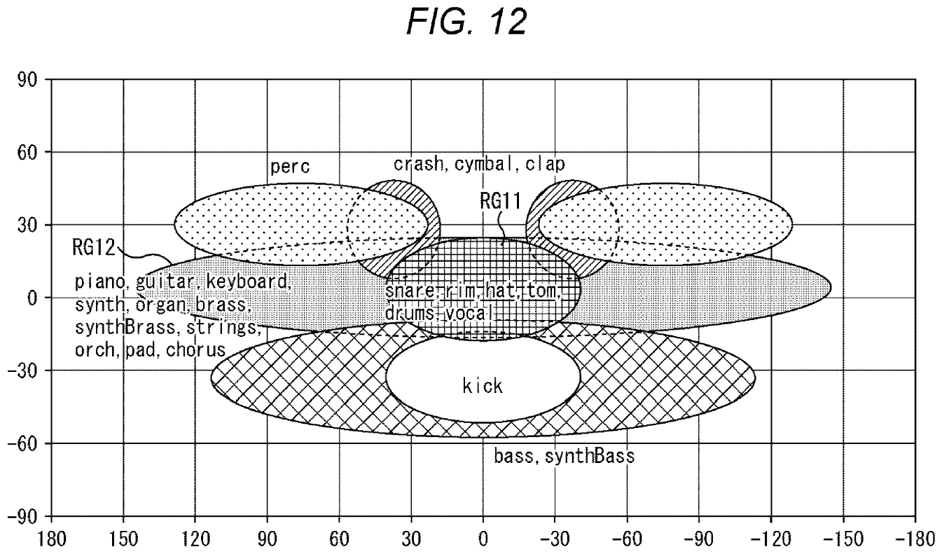

Furthermore, for example, as illustrated in FIG. 12, an approximate arrangement range of an object, that is, an approximate range of three-dimensional positional information as an output parameter of the object may be determined in advance for each “instrument type” as an object category.

In FIG. 12, the horizontal axis represents the azimuth angle “azimuth” indicating a position of an object in the horizontal direction, and the vertical axis represents the elevation angle “elevation” indicating a position of an object in the vertical direction.

Furthermore, a range indicated by each circle or ellipse indicates an approximate range of a value that can be taken as three-dimensional position information for an object of a predetermined instrument type.

Specifically, for example, a range RG11 indicates an approximate range of the three-dimensional position information as an output parameter of an object whose instrument type is “snare”, “rim”, “hat”, “tom”, “drums”, or “vocal”. That is, it indicates an approximate range of a position where the object may be arranged on a space.

Furthermore, for example, a range RG12 indicates an approximate range of three-dimensional position information as an output parameter of an object whose instrument type is “piano”, “guitar”, “keyboard”, “synth”, “organ”, “brass”, “synthBrass”, “strings”, “orch”, “pad”, or “chorus”.

Moreover, even within an approximate range (approximate arrangement range) of an arrangement position on the space, the arrangement position of the object may change according to an object feature amount of the object.

That is, the arrangement position (output parameter) of the object may be determined on the basis of the object feature amount of the object and the approximate arrangement range of the object determined for each instrument type. In this case, the control unit 26, that is, the output parameter calculation unit 66 and the output parameter adjustment unit 67 determine three-dimensional position information of the object for each object category on the basis of the object feature amount such that the three-dimensional position information as the output parameter has a value within the range determined in advance for each object category (instrument type).

Hereinafter, a specific example will be described.

For example, an object having a small value of the object feature amount “rise”, that is, an object having a short rise time plays a role of forming a rhythm of music, and thus, may be arranged on the front side within the above-described approximate arrangement range.

Furthermore, for example, an object having a small value of the object feature amount “rise” may be arranged on the upper side within the above-described approximate arrangement range in order to allow a sound of the object to be heard more clearly.

An object having a large value of the object feature amount “sound pitch” may be arranged on the upper side within the above-described approximate arrangement range since it is natural that a sound of the object is heard from the upper side. Conversely, an object having a small value of the object feature amount “sound pitch” may be arranged on the lower side within the above-described approximate arrangement range since it is natural that a sound of the object is heard from the lower side.

An object having a large value of the object feature amount “note density” plays the role of forming the rhythm of music, and thus, may be arranged on the front side within the above-described approximate arrangement range. On the other hand, an object having a small value of the object feature amount “note density” plays a role of being an accent in music, and thus, may be arranged to spread to the left and right within the above-described approximate arrangement range, or may be arranged on the upper side.

An object having a large value of the object feature amount “Lead Index” plays an important role in music, and thus, may be arranged on the front side within the above-described approximate arrangement range.

Moreover, an object of which the object category “role” is “Lead” plays an important role in music, and thus, may be arranged on the front side within the above-described approximate arrangement range. Furthermore, an object of which the object category “role” is “Not Lead” may be arranged to spread to the left and right within the above-described approximate arrangement range.

The arrangement position may be determined by the object category “tone type” in addition to the instrument type. For example, an object having the tone type “fx” may be arranged at an upper position such as azimuth=900 and elevation=60°. In this manner, the tone used as a sound effect in a song can be effectively delivered (played) to the user.

Furthermore, an object having a high degree of reverberation indicated by the object category “reverb type” or the object feature amount “reverb intensity” may be arranged on the upper side. This is because the object with high reverberation is more appropriate to be arranged on the upper side in order to represent spatial spread.

The adjustment regarding the object arrangement according to the object category and the object feature amount as described above can be implemented by appropriately defining an inclination of the conversion function, the change range, and the like defined by the internal parameter.

### (2.4. Adjustment of Output Parameter)

After the output parameter is calculated for each of the objects on the basis of the object feature amounts, positions (three-dimensional position information) between the objects and gains as the output parameters may be adjusted.

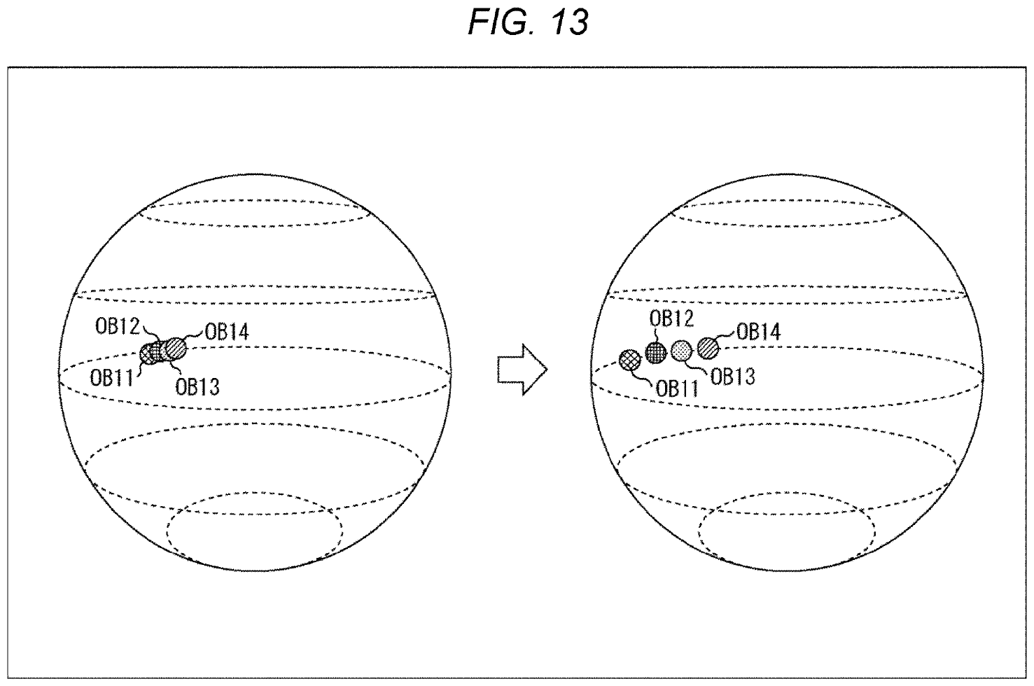

Specifically, as the adjustment of the position (three-dimensional position information) of the object, in a case where a plurality of objects is arranged at close positions on a space, for example, as illustrated in FIG. 13, processing of shifting the objects such that a distance between the objects is an appropriate distance is considered. Therefore, it is possible to prevent masking of a sound between the objects.

That is, for example, it is assumed that the arrangement on the space of each of objects OB11 to OB14 indicated by the output parameter is the arrangement illustrated on the left side in the drawing. In this example, four objects OB11 to OB14 are arranged close to each other.

In this regard, for example, the output parameter adjustment unit 67 adjusts the three-dimensional position information as the output parameter of each of the objects, so that the arrangement of each of the objects on the space indicated by the adjusted output parameter can be the arrangement illustrated on the right side in the drawing. In the example illustrated on the right side in the drawing, the objects OB11 to OB14 are arranged at appropriate intervals, and masking of the sound between the objects can be suppressed.

In such an example, for example, it is conceivable that the output parameter adjustment unit 67 adjusts the three-dimensional position information for objects in which a distance between the objects is equal to or less than a predetermined threshold.

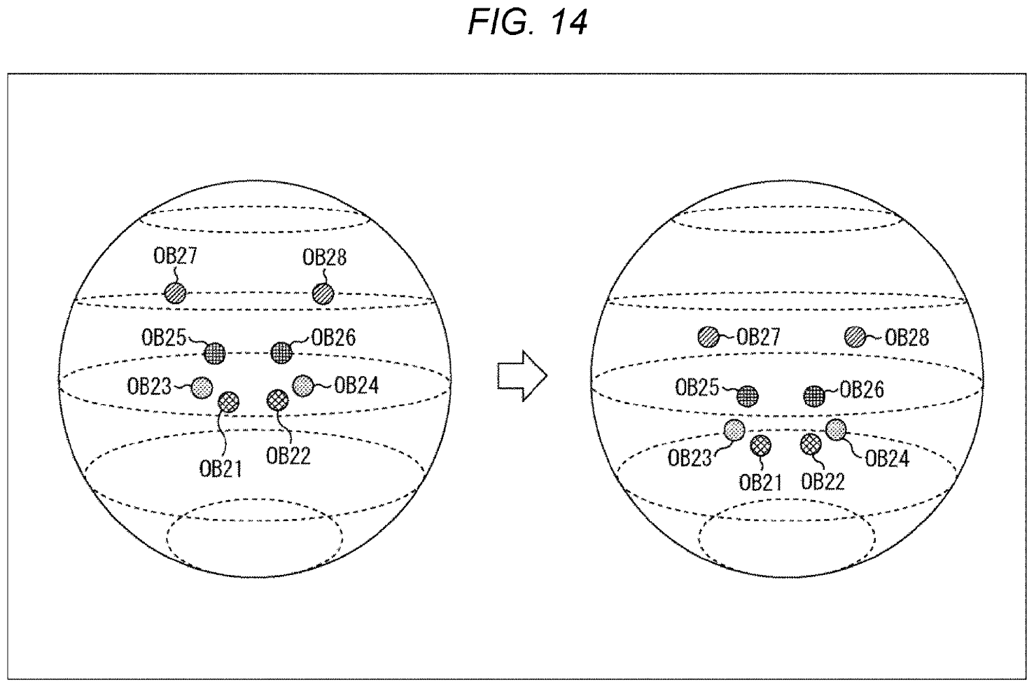

Furthermore, it is also conceivable to perform processing of eliminating a bias of an object as processing of adjusting the output parameter. Specifically, it is assumed that eight objects OB21 to OB28 are arranged on a space, for example, as illustrated on the left side of FIG. 14. In this example, each of the objects is arranged slightly on the upper side on the space.

In this case, for example, the output parameter adjustment unit 67 adjusts the three-dimensional position information as the output parameter of each of the objects, so that the arrangement of each of the objects on the space indicated by the adjusted output parameter can be the arrangement illustrated on the right side in the drawing.

In the example illustrated on the right side in the drawing, the objects OB21 to OB28 move to the lower side in the drawing while the relative positional relationship of the plurality of objects is maintained, and as a result, more appropriate object arrangement is achieved.

In such an example, it is conceivable that the output parameter adjustment unit 67 adjusts the three-dimensional position information of all the objects, for example, in a case where a distance between a barycentric position of an object group obtained from positions of all the objects and a position serving as a reference such as a center position of the three-dimensional space is equal to or more than a threshold.

Moreover, processing of widening or narrowing the arrangement of the plurality of objects using a certain point as the center may be performed.

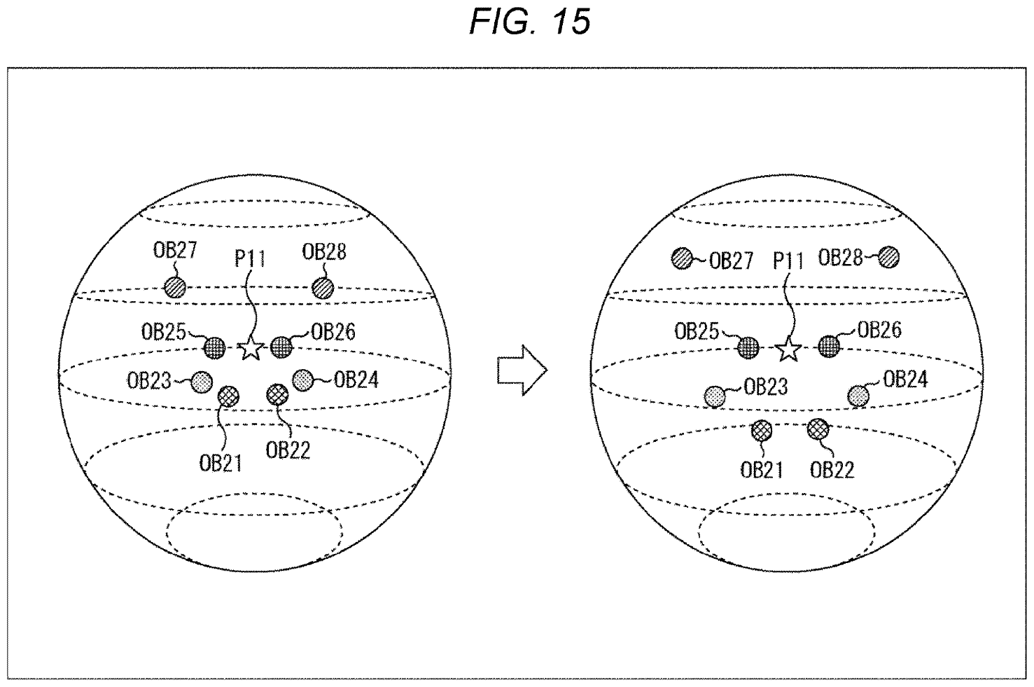

For example, it is assumed that the objects OB21 to OB28 are arranged on a space in the positional relationship illustrated on the left side of FIG. 15. Note that, in FIG. 15, portions corresponding to those in the case of FIG. 14 are denoted by the same reference signs, and the description thereof will be omitted as appropriate.

From such an object arrangement state, it is conceivable that the output parameter adjustment unit 67 adjusts the three-dimensional position information as the output parameter of each of the objects such that each of the objects moves from a position P11 serving as a predetermined reference to a more distant position (such that the object group spreads). Therefore, the arrangement on the space of each of the objects indicated by the adjusted output parameter can be the arrangement illustrated on the right side in the drawing.

In such an example, it is conceivable that the output parameter adjustment unit 67 adjusts the three-dimensional position information, for example, in a case where a total value of distances from the position P11 to the respective objects is out of a predetermined value range.

The above-described adjustment of the output parameter (three-dimensional position information) may be performed for all the objects of content, or may be performed only for some objects satisfying a specific condition (for example, objects tagged in advance on the user side).

As a specific example of the output parameter adjustment, in a case where an elevation angle indicating a barycentric position of an object group in an elevation angle direction regarding the object group whose instrument type is kick or bass is larger than a predetermined threshold determined from an elevation angle as the output parameter of a vocal, processing of moving the object group downward is conceivable.

In general, the kick and the bass are arranged below a horizontal plane, and the vocal is arranged on the horizontal plane in many cases. Here, when the elevation angles as the output parameters of the kick and the bass both become large values and the kick and the bass approach the horizontal plane, the kick and the bass approach the vocal arranged on the horizontal plane, and objects having important roles concentrate in the vicinity of the horizontal plane, which should be avoided. In this regard, it is possible to prevent the objects from being arranged to be biased in the vicinity of the horizontal plane by adjusting the output parameters of the objects such as the kick and the bass.

Furthermore, for example, adjustment in consideration of human psychoacoustics can be considered as the adjustment of gains as the output parameter. For example, a perceptual phenomenon is known in which a sound from the lateral direction is perceived to be larger than a sound from the front. It is conceivable to perform adjustment to slightly decrease a gain of an object such that a sound of the object arranged in the lateral direction as viewed from the user does not sound too loud on the basis of the psychoacoustics. Furthermore, a user suffering from hearing loss or using a hearing aid often has a symptom that it is difficult to hear a specific frequency, and adjustment in consideration of the psychoacoustics of a healthy person is not necessarily appropriate in some cases. Therefore, for example, a specification or the like of a hearing aid to be used may be input such that individual adjustment suitable for the specification is performed. Furthermore, a hearing test may be performed on the user in advance on the system side, and the output parameter may be adjusted on the basis of the result.

### (3. User Interface for Adjusting Algorithm of Automatic Mixing)

For example, in order to cope with an individual difference in the way of thinking for each mixing engineer, the automatic mixing algorithm described in “2. Algorithm of Automatic Mixing” described above may be adjusted by an internal parameter that can be understood by a user.

For example, in a state in which the information processing apparatus 11 functions as the automatic mixing apparatus 51, the control unit 26 may present internal parameters of the output parameter calculation function, that is, the internal parameters for adjusting the behavior of the algorithm to the user, such that the user can select a desired internal parameter from candidates or adjust the internal parameters.

In such a case, for example, the control unit 26 causes the display unit 22 to display an appropriate user interface (image) for adjustment or selection of the internal parameter of the output parameter calculation function.

Then, the user performs an operation on the displayed user interface to select a desired internal parameter from the candidates or adjust the internal parameter. Then, the control unit 26, more specifically, the parameter adjustment unit 69 adjusts the internal parameter or selects the internal parameter according to the user's operation on the user interface.

Note that the user interface presented (displayed) to the user is not limited to one for adjusting or selecting the internal parameter of the output parameter calculation function, and may be one for adjusting or selecting the internal parameter to be used for adjustment of the output parameter performed by the output parameter adjustment unit 67. That is, the user interface presented to the user may be any user interface for adjusting or selecting the internal parameter to be used for determining the output parameter based on the attribute information.

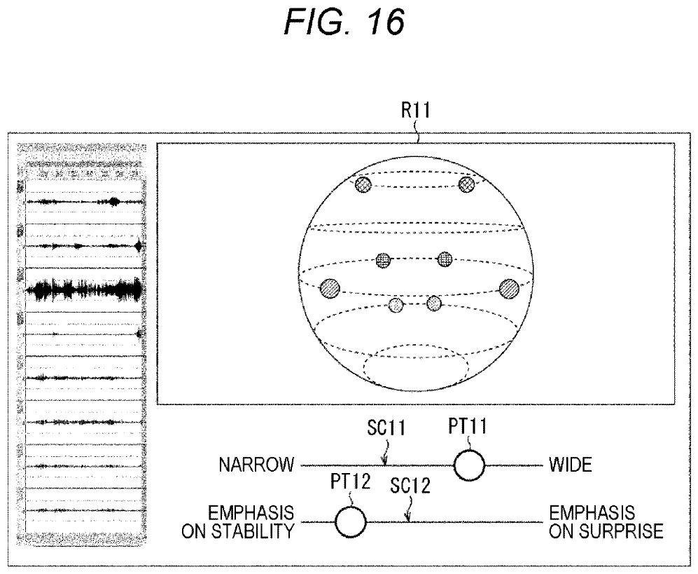

Hereinafter, an example of such a user interface will be described with reference to FIGS. 16 to 24. Note that an example of adjusting (determining) an azimuth angle and an elevation angle among three-dimensional positions of an object (audio object) as output parameters will be described hereinafter.

### UI Example 1: Scroll Bar for Adjusting Overall Tendency of Three-Dimensional Position

For example, the control unit 26 causes the display unit 22 to display a display screen of the 3D audio production/editing tool illustrated in FIG. 16. A scroll bar for adjusting a determination tendency for the azimuth angle and the elevation angle of the entire object is displayed on the display screen.

In this example, an arrangement position of each object on a space indicated by three-dimensional position information as the output parameter is displayed in a display region R11. Furthermore, a scroll bar SC11 and a scroll bar SC12 are displayed as user interfaces (UI).

For example, characters “narrow” and “wide” corresponding to concepts of whether to decrease or increase a value of the azimuth angle or the elevation angle are displayed at (near) both ends of the scroll bar SC11, instead of a name of an internal parameter of the output parameter calculation function that performs adjustment and an actual numerical value of the internal parameter.

When the user moves a pointer PT11 on the scroll bar SC11 along the scroll bar SC11, the parameter adjustment unit 69 changes (determines) an internal parameters of the output parameter calculation function, that is, an internal parameter of the algorithm according to a position of the pointer PT11, and supplies the changed internal parameter to the parameter holding unit 70 to be held therein. Therefore, the finally arranged azimuth angle and elevation angle of the object change.

For example, the internal parameter of the output parameter calculation function is adjusted (determined) such that the output parameter calculation function has a tendency that the azimuth angle and the elevation angle are determined so as to narrow an interval between a plurality of the objects as the user moves the pointer PT11 to the left side in the drawing.

Furthermore, characters “emphasis on stability” and “emphasis on surprise” indicating whether or not a value of the azimuth angle or the elevation angle is a standard for the object are displayed at (near) both ends of the scroll bar SC12.

For example, as the user moves a pointer PT12 to the left side in the drawing, the internal parameter of the output parameter calculation function is adjusted (determined) by the parameter adjustment unit 69 so as to obtain the output parameter calculation function having a tendency that the azimuth angle and the elevation angle are determined such that the arrangement of the object on the space becomes closer to the arrangement used in general (standard).

Such display of the scroll bar SC11 and the scroll bar SC12 enables the user to perform intuitive adjustment with an intention such as “a desire to widen” or “a desire to bring a surprise” to the arrangement of the objects.

### UI Example 2: Drawing of Curve for Adjusting Change Range of Three-Dimensional Position

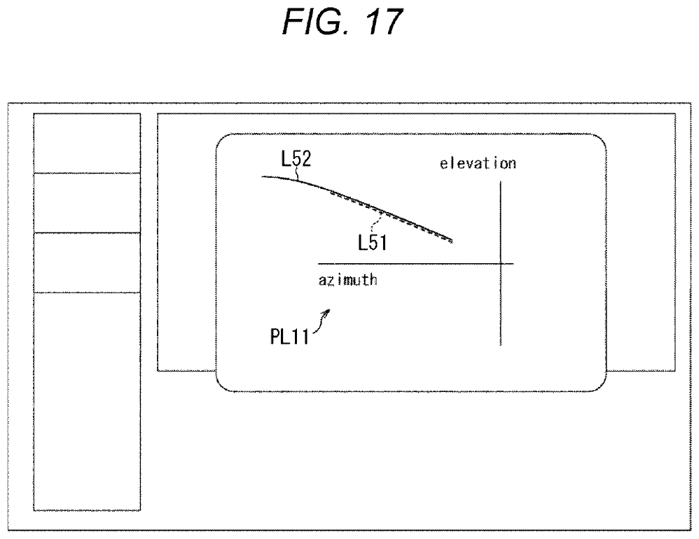

FIG. 17 illustrates an example of a user interface for drawing a curve representing a range in which a three-dimensional position of an object changes according to an object feature amount.

The azimuth angle and the elevation angle of the object are determined by the algorithm based on the output parameter calculation function, but change ranges of the azimuth angle and the elevation angle can be represented by a curve on a coordinate plane PL11 expressed by the azimuth angle and the elevation angle.

The user draws this curve by any input device serving as the input unit 21. Then, the parameter adjustment unit 69 regards a drawn curve L51 as the change ranges of the azimuth angle and the elevation angle, converts the curve L51 into internal parameters of the algorithm, and supplies the obtained internal parameters to the parameter holding unit 70 to be held therein.

For example, designating the change ranges indicated by the curve L51, that is, both ends of the curve L51 corresponds to designating a range of possible values of the azimuth angle “azimuth” in the graph indicated by the arrow Q35 in FIG. 11 and a range of possible values of the elevation angle “elevation” corresponding to the graph. At this time, the relationship between the azimuth angle “azimuth” and the elevation angle “elevation” output as the output parameters is the relationship indicated by the curve L51.

Such adjustment of the internal parameter by drawing the curve L51 may be performed for each content category or object category. For example, a change range of a three-dimensional position of an object according to an object feature amount can be adjusted for the music genre “pop” and the instrument type “kick”.

In such a case, for example, the display unit 22 is only required to display a pull-down list for designating a content category or an object category such that the user can designate the content category or the object category for which adjustment is to be performed from the pull-down list.

In this manner, for example, the user can reflect an intention to change the azimuth angle of the object belonging to the kick of certain pop music to a larger value, that is, to the rear side by an intuitive operation of drawing a curve.

In this case, for example, the user may rewrite the already drawn curve L51 into a curve L52 longer in the horizontal direction. Note that the curve L51 and the curve L52 are drawn so as not to overlap each other in order to make the drawing easy to see.

Furthermore, the change ranges of the azimuth angle and the elevation angle as the output parameters may be expressed by a plane or the like, instead of the curve, and the user may designate the change ranges by drawing such a plane or the like.

### Modification Example 1 of UI Example 2: Semi-Automatic Adjustment in Presentation of Sound Sample

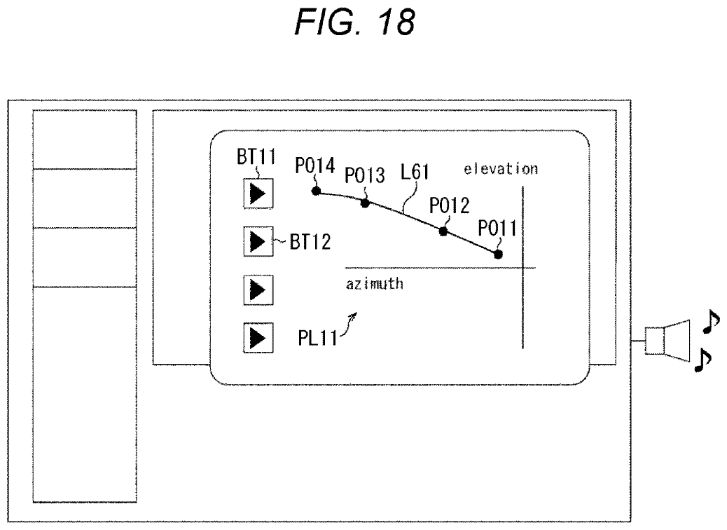

FIG. 18 illustrates an example of adjusting a change range of an output parameter by causing the user to actually hear a voice in which an object feature amount changes and causing the user to set the output parameter for each sound. Note that, in FIG. 18, same reference sign is assigned to a portion corresponding to that in the case of FIG. 17, and description thereof will be omitted as appropriate.

The curve expressing the change ranges of the azimuth angle and the elevation angle described in UI Example 2 may be depicted by listening to actual sounds with sufficiently changed object feature amounts and setting desired values of the azimuth angle and the elevation angle on a plane as the output parameters according to trial listening of the sounds.

In such a case, for example, a sample sound reproduction button BT11, the coordinate plane PL11, and the like illustrated in FIG. 18 are displayed on the display unit 22 as user interfaces.

For example, the user presses the sample sound reproduction button BT11, and listens to a voice with a sound having a very short rise output from the audio output unit 25 under the control of the control unit 26. Then, the user considers what is appropriate for the azimuth angle and the elevation angle in the case of the sound in the trial listening, and places the pointer PO11 at a position corresponding to the azimuth angle and the elevation angle that the user himself or herself considers appropriate on the coordinate plane PL11 of the azimuth angle and the elevation angle.

Furthermore, when the user presses a next sample sound reproduction button BT12 from among a plurality of sample sound reproduction buttons, a voice having a slightly longer rise than the case of the sample sound reproduction button BT11 is output (reproduced) from the audio output unit 25. Then, the user places the pointer P012 at a position on the coordinate plane PL11 corresponding to the reproduced voice, similarly to the case of the sample sound reproduction button BT11.

In this example, on the left side in the drawing, the sample sound reproduction buttons for reproducing a plurality of sample voices having different rises as object feature amounts, respectively, such as the sample sound reproduction button BT11, are provided. That is, the plurality of sample sound reproduction buttons is prepared, and variations having sufficient changes in the rise as the object feature amount are prepared as the sample voices corresponding to the sample sound reproduction buttons

The user presses the sample sound reproduction button to perform trial listening of the sample voice, and repeatedly performs work (operation) of placing the pointer at an appropriate position on the coordinate plane PL11 according to a result of the trial listening as many times as the number of the sample sound reproduction buttons. Therefore, for example, the pointer PO11 to a pointer PO14 are placed on the coordinate plane PL11, and a curve L61 representing change ranges of the azimuth angle and the elevation angle of the object is created by interpolation based on the pointers PO11 to PO14.

On the basis of the curve L61, the parameter adjustment unit 69 sets an internal parameter corresponding to the change ranges of the azimuth angle and the elevation angle indicated by the curve L61 as the adjusted internal parameter.

Note that, in this example, the curve L61 has not only the change ranges of the azimuth angle and the elevation angle but also information regarding a change rate with respect to an object feature amount, and the change rate can also be adjusted (controlled).

For example, in the curve L51 or the curve L52 in UI Example 2 illustrated in FIG. 17, it is possible to adjust only a range of change in which the azimuth angle and the elevation angle change from one end of the curve to the other end along the curve as the object feature amount changes. Therefore, any value that is to be taken between these curves is determined by interpolation performed inside the algorithm.

On the other hand, in the example of FIG. 18, in addition to the pointer PO11 and the pointer PO14 at both ends of the curve L61, values of the azimuth angle and the elevation angle can be adjusted by placing the pointer P012 and the pointer P013 at intermediate points. That is, the change rate of the azimuth angle and the elevation angle with respect to the change in the object feature amount can also be adjusted. Therefore, the user can intuitively adjust the change range of the output parameter while confirming with his or her own ear how the object feature amount actually changes.

### Modification Example 2 of UI Example 2: Slider

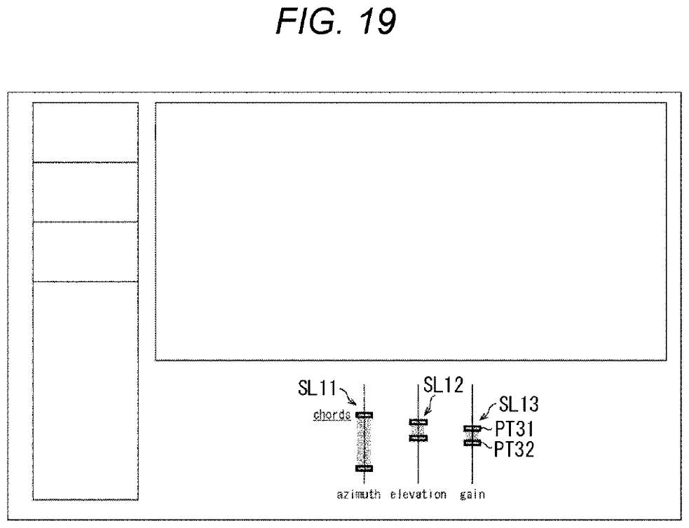

The change ranges of the azimuth angle and the elevation angle may be expressed and adjusted using a slider instead of on the coordinate plane having the both as the respective axes. In such a case, the display unit 22 displays a user interface illustrated in FIG. 19, for example.

In the example of FIG. 19, sliders SL11 to SL13 for adjusting the respective change ranges of the azimuth angle “azimuth”, the elevation angle “elevation”, and a gain “gain” of an object as the output parameters are displayed as user interfaces.

In particular, the slider SL13 is displayed here, and accordingly, the change range of the gain “gain” is added as an adjustment target.

For example, the user designates the change range of the gain “gain” by sliding (moving) a pointer PT31 and a pointer PT32 on the slider SL13 to any positions.

In this case, a section sandwiched between the pointer PT31 and the pointer PT32 is set as the change range of the gain “gain”. In UI Example 2 described above, the change ranges of the output parameters expressed in a shape of the curve are expressed by a set of pointers such as the pointer PT31 and the pointer PT32 in this example, and the user can intuitively designate the change ranges.

The parameter adjustment unit 69 changes (determines) an internal parameter of the output parameter calculation function according to positions of the pointer PT31 and the pointer PT32, and supplies the changed internal parameter to the parameter holding unit 70 to be held therein.

Similarly to the slider SL13, the user can adjust the change ranges of the azimuth angle “azimuth” and the elevation angle “elevation” by moving pointers on the slider SL11 and the slider SL12.

For example, in a case where a change range of an output parameter is adjusted by drawing a curve or a figure such as a plane, the expression by the figure or the like becomes complicated if there are three or more output parameters. However, if a slider for adjusting the change range is provided for each of the output parameters as in the example of FIG. 19, the intuitiveness of adjustment can be maintained.

Furthermore, in this example, characters “chords” indicating an instrument type as an object category are displayed for a slider group including the sliders SL11 to SL13.

For example, a user interface such as a pull-down list from which a content category or an object category can be selected may be provided such that the user can select a content category or an object category for which adjustment using the slider group is to be performed.

Furthermore, for example, the slider group including the sliders SL11 to SL13 may be provided for each content category or object category such that the slider group for a desired category can be displayed when the user switches a display tab or the like.

### UI Example 3: Scroll Bar for Adjusting Contribution Degree to Three-Dimensional Position

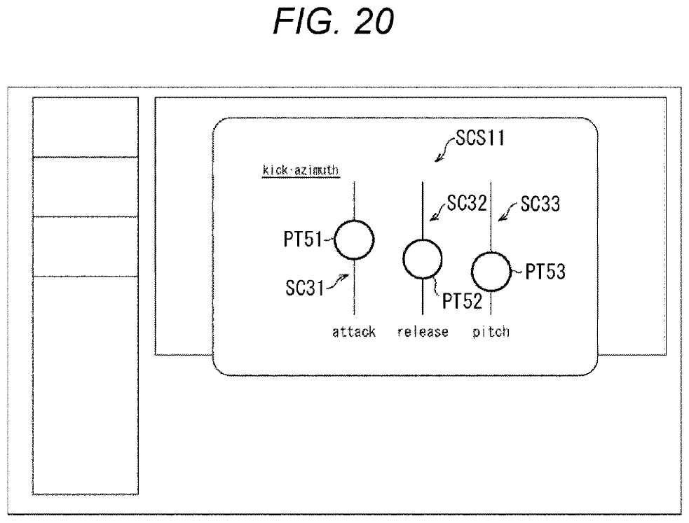

FIG. 20 illustrates an example of a scroll bar by which the magnitude of a contribution degree of each object feature amount affecting a change in an output parameter can be adjusted for each output parameter for each category such as an object category or a content category.

In this example, a scroll bar group SCS11 for adjusting contribution degrees of object feature amounts to an output parameter is displayed as a user interface for each combination of a category and the output parameter.

The scroll bar group SCS11 includes scroll bars SC31 to SC33 as many as the number of object feature amounts whose contribution degrees can be adjusted.

That is, the scroll bars SC31 to SC33 are configured to adjust the contribution degrees of the rise “attack”, the duration “release”, and the sound pitch “pitch”, respectively. The user adjusts (changes) the contribution degree of each of the object feature amounts by changing a position of each of pointers PT51 to PT53 provided in the scroll bars SC31 to SC33.

The parameter adjustment unit 69 changes (determines) the contribution degree as an internal parameter of the output parameter calculation function in accordance with the position of the pointer on the scroll bar corresponding to the object feature amount, and supplies the changed internal parameter to the parameter holding unit 70 to be held therein.

For example, in a case where the user desires to determine the arrangement of objects with more emphasis on the duration, the user moves the pointer PT52 of the scroll bar SC32 corresponding to the duration, and adjusts the contribution degree of the duration to be higher.

Therefore, the user can select what is to be emphasized for the output parameter from among understandable object feature amounts such as “rise” and “duration”, and intuitively adjust the contribution degree (weight) of the object feature amount.

Note that a user interface for selecting a category and an output parameter for which the contribution degree is to be adjusted may be provided also in this example.

### UI Example 4: Slider for Adjusting Contribution Range to Three-Dimensional Position

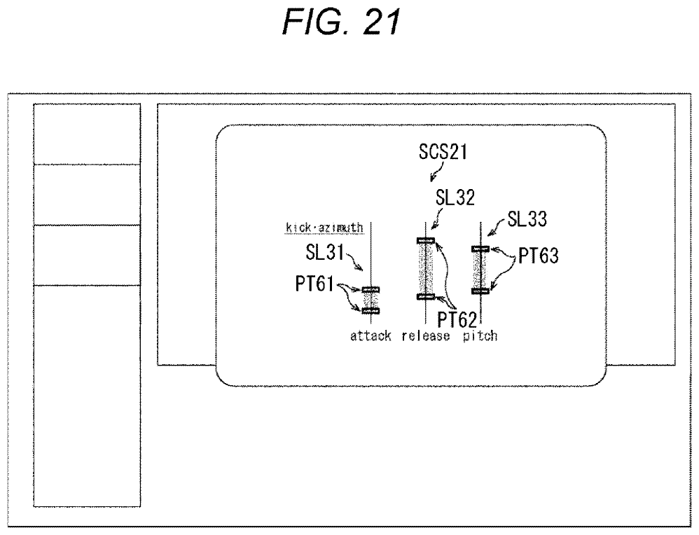

FIG. 21 illustrates an example of a slider by which a contribution range, which is a range of values of each object feature amount affecting a change in an output parameter, can be adjusted for each output parameter for each category such as an object category or a content category.

In this example, a slider group SCS21 for adjusting contribution ranges of object feature amounts to an output parameter is displayed as a user interface for each combination of a category and the output parameter.

The slider group SCS21 includes sliders SL31 to SL33 as many as the object feature amounts whose contribution ranges can be adjusted.

That is, the sliders SL31 to SL33 are configured to adjust the contribution ranges of the rise “attack”, the duration “release”, and the sound pitch “pitch”, respectively. The user adjusts (changes) the contribution range of each of the object feature amounts by changing positions of each of pointers PT61 to PT63 as sets of two pointers provided in the sliders SL31 to SL33.

The parameter adjustment unit 69 changes (determines) the contribution range as an internal parameter of the output parameter calculation function in accordance with the positions of the pointers on the slider corresponding to the object feature amount, and supplies the changed internal parameter to the parameter holding unit 70 to be held therein.

For example, when the user changes the positions of the respective pointers on the slider, any range in which the output parameter is affected by a change in a value of the object feature amount, that is, the contribution range is determined according to the positions of the respective pointers, and an internal parameter is changed according to the contribution range. The positions of the respective pointers are displayed so as to be visually correlated with the magnitude and range of an actual value of the object feature amount.

For example, it is assumed that the user desires to narrow the contribution range of the rise “attack” regarding determination of the azimuth angle “azimuth” of the kick “kick”. In such a case, the user is only required to narrow an interval of the pointers PT61 of the slider SL31 corresponding to the rise “attack”.

At this time, the internal parameter is changed, and the azimuth angle also changes according to the change when the rise is within a certain range (which corresponds to a range of values of 50 to 100, for example)/On the other hand, when the rise is out of the certain range (50 or less or 100 or more), the determination of the azimuth angle is not affected even if a value of the rise changes more. This prevents the output parameter from being affected by an extremely short or long rise.

On the other hand, the duration can be adjusted to widely affect the azimuth angle from a very short time to a very long time, for example, by widening an interval of the pointers PT62 of the slider SL32 corresponding to the duration.

With the above user interface, the user can adjust the contribution range of the understandable object feature amount such as “rise” or “duration” to the output parameter with the intuitive expression of the interval of the pointers on the slider.

Note that a user interface for selecting a category and an output parameter for which the contribution range is to be adjusted may be provided also in this example.

The user can adjust (customize) the internal parameters of the output parameter calculation function illustrated in FIG. 11, for example, by adjusting a desired internal parameter while switching the display screens illustrated in FIGS. 19 to 21, for example. Therefore, the behavior of the algorithm can be optimized according to a taste of the user, and the usability of the 3D audio production/editing tool can be improved.

### UI Example 5: Drawing for Adjusting Conversion Function from Object Feature Amount to Three-Dimensional Position

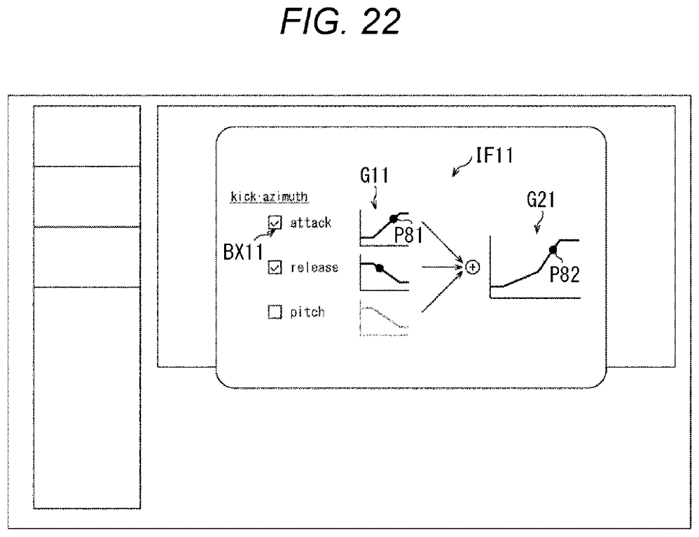

Moreover, as an example of adjusting an internal parameter in a more advanced manner, an example of a user interface for adjusting a graph shape indicating a mathematical function by which each object feature amount is converted into an output parameter such as the azimuth angle or the elevation angle is illustrated in FIG. 22.

In this example, as illustrated in FIG. 22, a user interface IF11 for adjustment of an internal parameter for each combination of a category, such as an object category or a content category, and an output parameter is displayed. The following functions are provided by the user interface IF11.
A check box for selecting an object feature amount contributing to determination of an output parameter
An adjustment function of processing a graph representing a first conversion function of the object feature amount selected in the check box and a graph shape of the first conversion function
A graph representing a second conversion function that combines outputs of the first conversion function and performs conversion into an output parameter
An adjustment function of processing a graph shape of the second conversion function

For example, as the graph of the first conversion function, a line graph in which the horizontal axis represents an object feature amount as an input and the vertical axis represents a conversion result of the object feature amount is conceivable. Similarly, for example, as the second conversion function, a line graph in which the horizontal axis represents a combined result of the outputs of the first conversion function as an input and the vertical axis represents the output parameter is conceivable. These graphs may be other known displays that visually represent the relationship of two variables.

In the example of FIG. 22, the check box for selecting an object feature amount is displayed on the user interface IF11.

For example, when the user causes a check mark to be displayed in a selected state in a check box BX11, the rise “attack” corresponding to the check box BX11 is selected as the object feature amount contributing to determination of the azimuth angle “azimuth” which is the output parameter.

Such a selection operation on the check box corresponds to the adjustment of the internal parameter corresponding to the portion indicated by the arrow Q31 in FIG. 11, that is, the above-described selection portion FXP1.

Furthermore, a graph Gil is the graph of the first conversion function that converts the rise “attack” as the object feature amount into a value corresponding to a value of the rise “attack”. For example, the graph Gil corresponds to the graph of the portion indicated by the arrow Q32 in FIG. 11, that is, a part of the combining portion FXP2 described above.

In particular, an adjustment point P81 for implementing the adjustment function of processing (deforming) the graph shape of the first conversion function is provided on the graph Gil, and the user can deform the graph shape into any shape by moving the adjustment point P81 to any position. This adjustment point P81 corresponds to, for example, a point (coordinate) for prescribing the input/output relationship in the graph of the portion indicated by the arrow Q32 in FIG. 11.

Note that the number of adjustment points provided on the graph of the first conversion function may be freely set, and the user may be allowed to designate the number of adjustment points.

A graph G21 is the graph of the second conversion function that converts one value, obtained by combining outputs of the first conversion function for one or a plurality of object feature amounts, into an output parameter. For example, the graph G21 corresponds to the graph of the portion indicated by the arrow Q35 in FIG. 11, that is, the above-described conversion portion FXP3.

In particular, an adjustment point P82 for implementing the adjustment function of processing (deforming) the graph shape of the second conversion function is provided on the graph G21, and the user can deform the graph shape into any shape by moving the adjustment point P82 to any position. This adjustment point P82 corresponds to, for example, a point (coordinate) for prescribing the input/output relationship in the graph of the portion indicated by the arrow Q35 in FIG. 11.

Note that the number of adjustment points provided on the graph of the second conversion function may be freely set, and the user may be allowed to designate the number of adjustment points.

The adjustment function of processing a graph shape is provided as the user manipulates positions of one or a plurality of adjustment points on a graph and creating the graph to interpolate between those adjustment points.

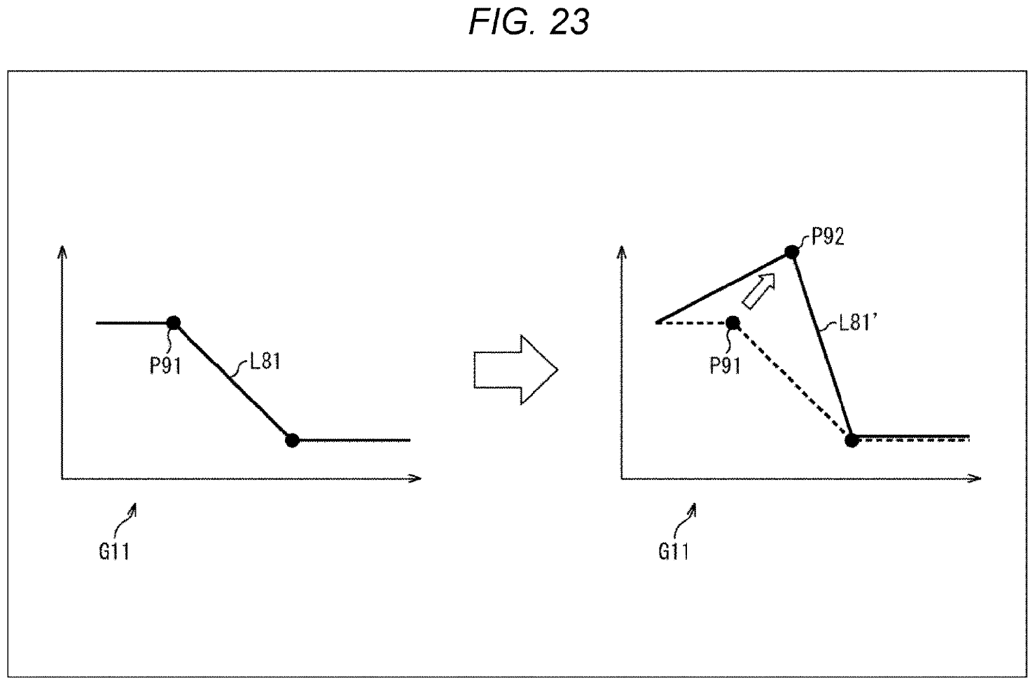

Here, an example of the adjustment of a graph shape by the user is illustrated in FIG. 23. Note that, in FIG. 23, same reference sign is assigned to a portion corresponding to that in the case of FIG. 22, and description thereof will be omitted as appropriate.

For example, it is assumed that the graph Gil is represented by a polygonal line L81 as illustrated on the left side in the drawing, and two adjustment points including an adjustment point P91 are arranged on the graph Gil.

At this time, it is assumed that the user operates the input unit 21 to move the adjustment point P91 on the graph Gil as illustrated on the right side in the drawing.

In the drawing, an adjustment point P92 indicates the adjustment point P91 after the movement on the right side.

When the adjustment point P91 is moved in this manner, the parameter adjustment unit 69 creates a new polygonal line L81′ to interpolate between the moved adjustment point P92 and another adjustment point.

Therefore, a shape of the graph Gil and the first conversion function represented by the graph Gil are processed.

Returning to the description of FIG. 22, for example, it is assumed that the user desires to adjust the way of reflection in consideration of only the rise “attack” and the duration “release” regarding the determination of the azimuth angle “azimuth” of the kick “kick”.

In such a case, the user causes a check mark to be displayed only in the check box BX11 of the rise “attack” and a check box of the duration “release”, and freely processes the graph Gil of the rise and a graph of the duration, and a shape of the graph G21.

Then, the parameter adjustment unit 69 changes (determines) an internal parameter of the output parameter calculation function according to the result of selection of the check boxes, the shape of the graph indicating the first conversion function, and the shape of the graph indicating the second conversion function, and supplies the changed internal parameter to the parameter holding unit 70 to be held therein. In this manner, it is possible to adjust the internal parameter so as to obtain a desired output parameter calculation function.

In particular, in this example, the user can adjust the conversion process from the understandable object feature amount to the output parameter with a very high degree of freedom.

Furthermore, in this example, the conversion from the object feature amount to the output parameter is expressed by two-stage graphs, that is, the first conversion function and the second conversion function, and the adjustment of the internal parameter corresponding to these conversion functions can be performed. However, even if the number of stages of graphs for the conversion from the object feature amount to the output parameter is different, the adjustment of the internal parameter can be implemented by a similar user interface.

### UI Example 6: Selection of Pattern from Pull-Down List

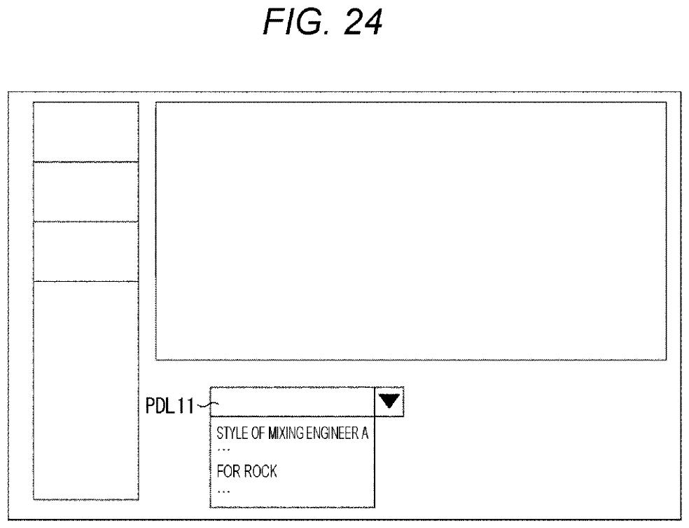

FIG. 24 illustrates an example of a user interface for displaying a pattern regarding the determination tendency of the output parameter in a pull-down list to be selectable from a plurality of options.

As described above, the tendency to determine the output parameter from features of objects and the like is different depending on a style of a mixing engineer and a music genre. That is, the internal parameters of the algorithm are different for each of these features, and a set of the internal parameters is prepared with a name such as “Style of mixing engineer A” or “For Rock”.

That is, a plurality of internal parameter sets including all the internal parameters constituting the output parameter calculation function is prepared in advance, and the name such as “Style of mixing engineer A” is attached to each of the internal parameters different from each other.

When the user opens a pull-down list PDL11 displayed as the user interface, the display unit 22 displays names of the plurality of internal parameter sets prepared in advance. Then, when the user selects any of these names, the parameter adjustment unit 69 causes the parameter holding unit 70 to output the internal parameter set of the name selected by the user to the output parameter calculation function determination unit 65.

Therefore, the output parameter calculation unit 66 calculates an output parameter using an output parameter calculation function determined by the internal parameter set of the name selected by the user.

Specifically, for example, it is assumed that the user opens the pull-down list PDL11 and selects an option “For Rock” from the pull-down list PDL11.

In such a case, the internal parameters of the algorithm (output parameter calculation function) are changed so as to be suitable for Rock or to obtain an output parameter typical of Rock, and as a result, the output parameter regarding the audio object is also suitable for Rock.

Therefore, the user can easily switch characteristics for each style of the mixing engineer or music genre that is desired to be adopted, and can take the characteristics into the determination tendency of the output parameter.

With the user interfaces illustrated in the respective examples described above, the user can perform fine adjustment performed in a case where a determined output parameter does not match a taste or an intention of musical expression on the algorithm (output parameter calculation function) itself in advance. Therefore, fine adjustment of an output parameter every time can be reduced, and a mixing time can be shortened. Moreover, the user interfaces for the adjustment are expressed in words that can be understood by the user, and thus, an artistic value of the user can be reflected in the algorithm.

For example, it is assumed that the user desires to greatly change the elevation angle in the arrangement of objects with more emphasis on the rise of a sound included in each of the objects.

In such a case, the user is only required to adjust an internal parameter by moving the pointer PT51 of the scroll bar SC31 of “rise” in UI Example 3 described above, that is, FIG. 20. The user can adjust parameters constituting metadata such as the object arrangement on the basis of the parameter (object feature amount) that can be understood by a music producer, that is, the rise of the sound.

Furthermore, the internal parameters for adjusting the behavior of the automatic mixing algorithm can include not only parameters of the output parameter calculation function but also parameters used for adjustment of the output parameter in the output parameter adjustment unit 67.

In this regard, a user interface for adjusting an internal parameter used in the output parameter adjustment unit 67 may also be displayed on the display unit 22 similarly to the examples described with reference to FIGS. 16 to 24, for example.

In such a case, when the user performs an operation on the user interface, the parameter adjustment unit 69 adjusts (determines) an internal parameter according to the operation of the user, and supplies the adjusted internal parameter to the output parameter adjustment unit 67. Then, the output parameter adjustment unit 67 adjusts an output parameter using the adjusted internal parameter supplied from the parameter adjustment unit 69.

### (4. Automatic Optimization According to Taste of User)

In the present technology, the automatic mixing apparatus 51 can also have a function of automatically optimizing the automatic mixing algorithm according to a taste of a user.

For example, it is considered to optimize the internal parameters of the algorithm described in “2.3. Mathematical Function for Calculating Output Parameter from Object Feature Amount” and “2.4. Adjustment of Output Parameter” described above.

In the optimization of the internal parameters, mixing examples of some pieces of music by a target user are referred to as learning data, and the internal parameters of the algorithm are adjusted such that three-dimensional position information and a gain as close as possible to those pieces of learning data can be output as output parameters.

In general, more learning data is required as the number of parameters to be optimized increases in order to optimize the algorithm. However, since the automatic mixing algorithm based on the object feature amounts proposed in the present technology can be expressed with a few internal parameters as described above, it is possible to perform sufficient optimization even in a case where there are few mixing examples of the target user.

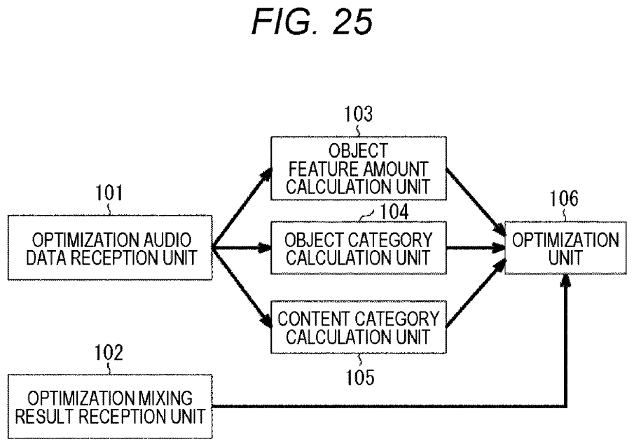

In a case where the automatic mixing apparatus 51 has an automatic optimization function of internal parameters according to the user's taste, the control unit 26 executes a program to implement, for example, functional blocks illustrated in FIG. 25 in addition to the functional blocks illustrated in FIG. 2 as functional blocks constituting the automatic mixing apparatus 51.

In the example illustrated in FIG. 25, the automatic mixing apparatus 51 includes an optimization audio data reception unit 101, an optimization mixing result reception unit 102, an object feature amount calculation unit 103, an object category calculation unit 104, a content category calculation unit 105, and an optimization unit 106 as the functional blocks for the automatic optimization of internal parameters.

Note that the object feature amount calculation unit 103 to the content category calculation unit 105 correspond to the object feature amount calculation unit 62 to the content category calculation unit 64 illustrated in FIG. 2.

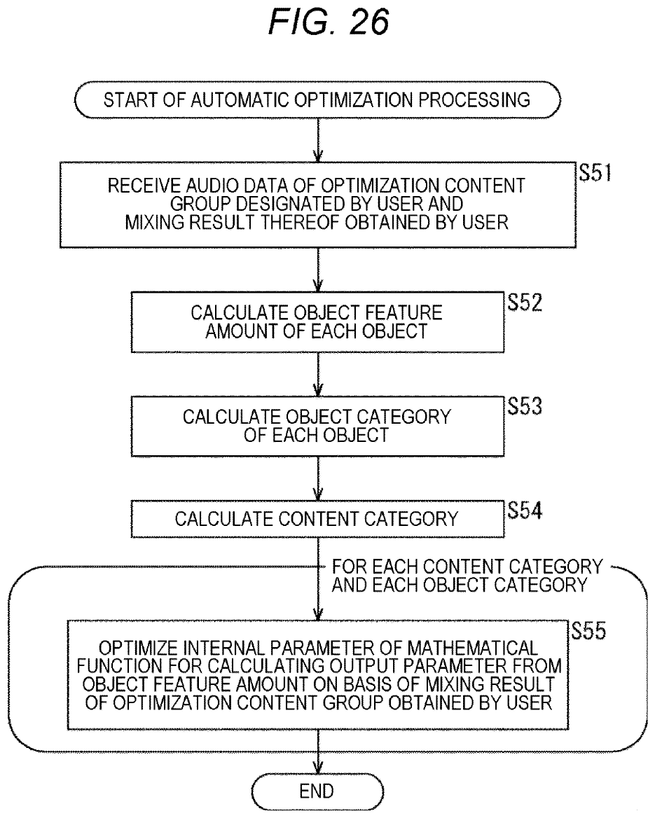

Next, operations of the optimization audio data reception unit 101 to the optimization unit 106 will be described. That is, the automatic optimization processing by the automatic mixing apparatus 51 will be described hereinafter with reference to a flowchart of FIG. 26.

The user prepares, in advance, audio data of each of objects of content (hereinafter, also referred to as optimization content) to be used for optimization and a mixing result for each of the objects of pieces of the optimization content obtained by the user himself or herself.

The mixing result referred to herein includes three-dimensional position information and a gain as output parameters determined by the user in the mixing of pieces of the optimization content. Note that one or a plurality of pieces of the optimization content may be used.

In step S51, the optimization audio data reception unit 101 receives the audio data of each of the objects of an optimization content group designated (input) by the user, and supplies the audio data to the object feature amount calculation unit 103 to the content category calculation unit 105.

Furthermore, the optimization mixing result reception unit 102 receives a result of mixing by the user of the optimization content group designated by the user, and supplies the mixing result to the optimization unit 106.

In step S52, the object feature amount calculation unit 103 calculates an object feature amount of each of the objects on the basis of the audio data of each of the objects supplied from the optimization audio data reception unit 101, and supplies the object feature amount to the optimization unit 106.

In step S53, the object category calculation unit 104 calculates an object category of each of the objects on the basis of the audio data of each of the objects supplied from the optimization audio data reception unit 101, and supplies the object category to the optimization unit 106.

In step S54, the content category calculation unit 105 calculates a content category of each piece of the optimization content on the basis of the audio data of each of the objects supplied from the optimization audio data reception unit 101, and supplies the content category to the optimization unit 106.

In step S55, the optimization unit 106 optimizes internal parameters of a function (output parameter calculation function) that calculates output parameters from the object feature amount on the basis of the mixing result of the optimization content group by the user.

That is, the optimization unit 106 optimizes the internal parameters of the output parameter calculation function on the basis of the object feature amount from the object feature amount calculation unit 103, the object category from the object category calculation unit 104, the content category from the content category calculation unit 105, and the mixing result from the optimization mixing result reception unit 102.

In other words, the internal parameters of the algorithm are optimized such that output parameters as close as possible to the mixing result by the user can be output with respect to the calculated object feature amount, object category, and content category.

Specifically, for example, the optimization unit 106 optimizes (adjusts) the internal parameters of the function that calculates the output parameters from the object feature amount defined for each content category and each object category by any technique such as a least squares method.

The optimization unit 106 supplies the internal parameters obtained by the optimization to the parameter holding unit 70 illustrated in FIG. 2 to be held therein. When the internal parameters are optimized, the automatic optimization processing ends.

Note that, in step S55, it is sufficient to perform optimization of an internal parameter used for determination of an output parameter based on attribute information. That is, the internal parameter to be optimized is not limited to the internal parameter of the output parameter calculation function, and may be an internal parameter used for output parameter adjustment performed by the output parameter adjustment unit 67, or may be both of these internal parameters.

As described above, the automatic mixing apparatus 51 optimizes the internal parameters on the basis of the audio data of the optimization content group and the mixing result.

In this manner, it is possible to obtain the internal parameters suitable for the user even if the user does not perform an operation on the above-described user interfaces, and thus, it is possible to improve the usability of the 3D audio production/editing tool, that is, a satisfaction level of the user.

The contents described above are based on the assumption that a mixing engineer who is mainly a person with a healthy hearing sense is the main user, but there are users suffering from hearing loss or using a hearing aid among users. For such users, for example, there are many cases where there is a symptom that it is difficult to hear a specific frequency, and there is a case where the above-described output parameter adjustment or the like in consideration of the psychoacoustics of the person with the healthy hearing sense is not necessarily appropriate.

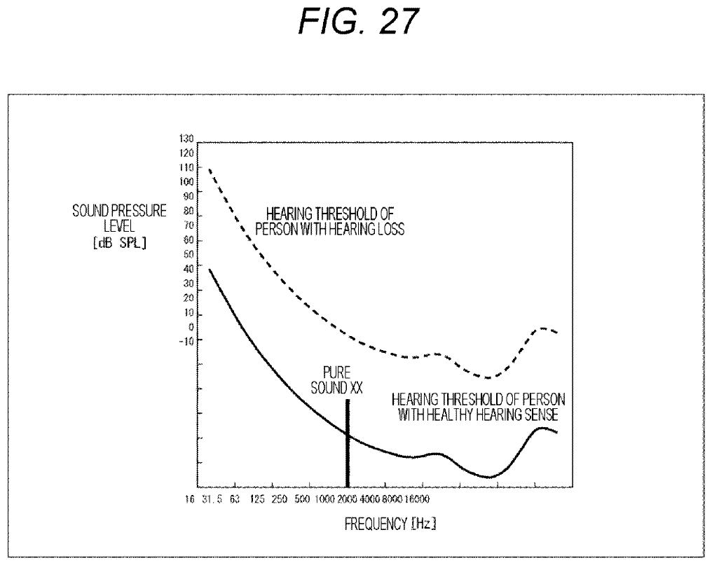

FIG. 27 illustrates an example in which a hearing threshold (threshold as to whether it is slightly heard or not heard) of a person with hearing loss increases, where the horizontal axis represents a frequency and the vertical axis represents a sound pressure level.

A curve of a broken line (dotted line) in the drawing indicates the hearing threshold of the person with hearing loss, and a curve indicated by a solid line indicates a hearing threshold of the person with the healthy hearing sense. Pure sound XX can be heard by the person with the healthy hearing sense but cannot be heard by the person with hearing loss. That is, it can be said that the hearing of the person with hearing loss has a hearing sense deteriorated by an interval between the curve depicted by the broken line and the curve depicted by the solid line as compared with the person with the healthy hearing sense, and thus, it is necessary to perform optimization individually.

In this regard, in the present technology, a specification or the like of a hearing aid or a sound collector to be used may be input such that individual adjustment suitable for the specification is performed. Furthermore, a hearing test may be performed on the user in advance on the system side, and the output parameter may be adjusted on the basis of the result.

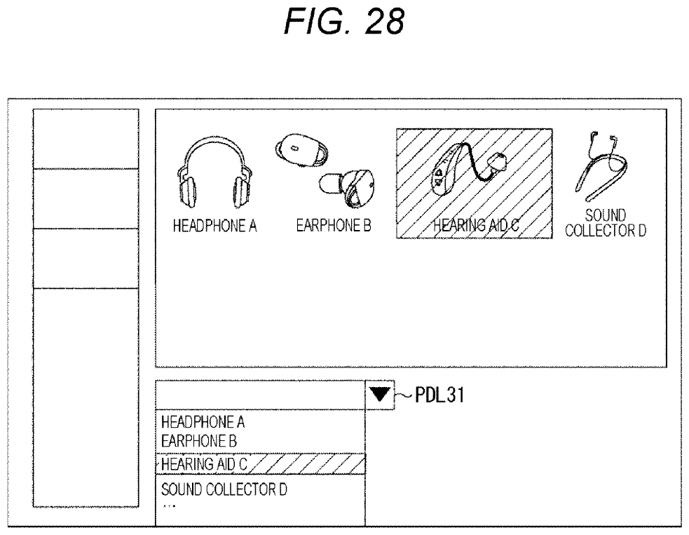

A device to be used at the time of mixing may be selectable on the user side, and such an example is illustrated in FIG. 28. FIG. 28 illustrates an example of a user interface that allows the user to select a device to be used at the time of mixing from among devices such as a headphone, an earphone, a hearing aid, and a sound collector registered in advance by the user, for example. In this example, for example, the user selects a device to be used at the time of mixing from a pull-down list PDL31 as the user interface. Then, for example, the output parameter adjustment unit 67 adjusts an output parameter such as a gain according to the device selected by the user.

When the device to be used at the time of mixing is selected in this manner, it is possible to cope with both a user who is a person with a healthy hearing sense and a user who has hearing loss or hearing impairment, and even a user who uses a hearing aid or the like can efficiently perform mixing work similarly to the person with the healthy hearing sense.

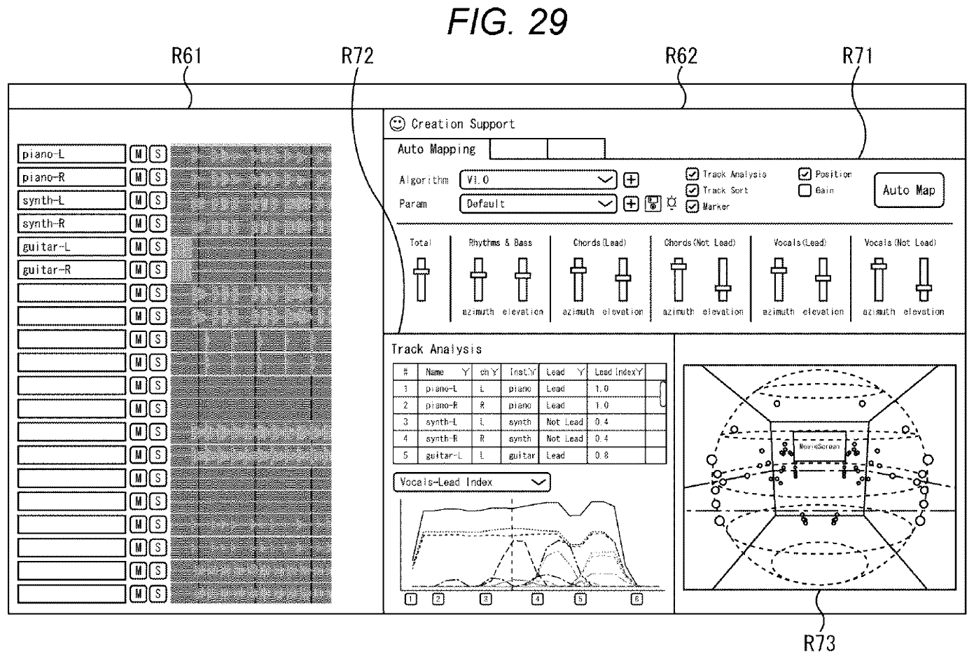

(Example of User Interface of 3D Audio production/editing Tool) Meanwhile, when the control unit 26 executes a program to implement the 3D audio production/editing tool for producing or editing content, a display screen of the 3D audio production/editing tool illustrated in FIG. 29 is displayed on the display unit 22, for example.

In this example, two display regions R61 and R62 are provided on the display screen of the 3D audio production/editing tool.

Furthermore, a display region R71 in which user interfaces for adjustment, selection, and the like regarding mixing are displayed, an attribute display region R72 for display regarding attribute information, and a mixing result display region R73 in which a mixing result is displayed are provided in the display region R62.

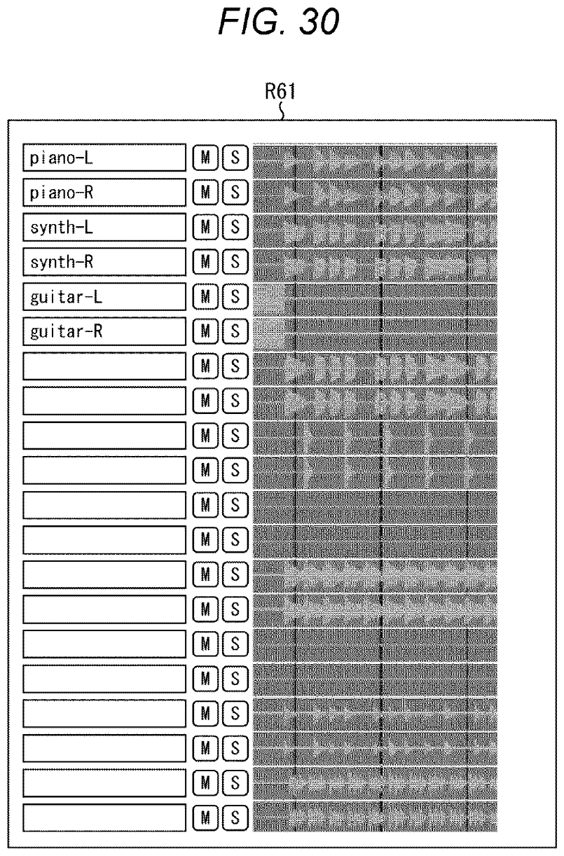

Hereinafter, the respective display regions will be described with reference to FIGS. 30 to 34.

The display region R61 is provided on the left side of the display screen of the 3D audio production/editing tool. For example, as illustrated in FIG. 30, the display region R61 is provided with a display field of a name of each of the objects, mute and solo buttons, and a waveform display area in which a waveform of audio data of the objects is displayed, similarly to a general content production tool.

Furthermore, the display region R62 provided on the right side of the display screen is a portion related to the present technology, and the display region R62 is provided with various user interfaces for adjustment, selection, an execution instruction, and the like regarding mixing, such as a pull-down list, a slider, a check box, and a button.

Note that the display region R62 may be displayed as a separate window with respect to the portion of the display region R61.

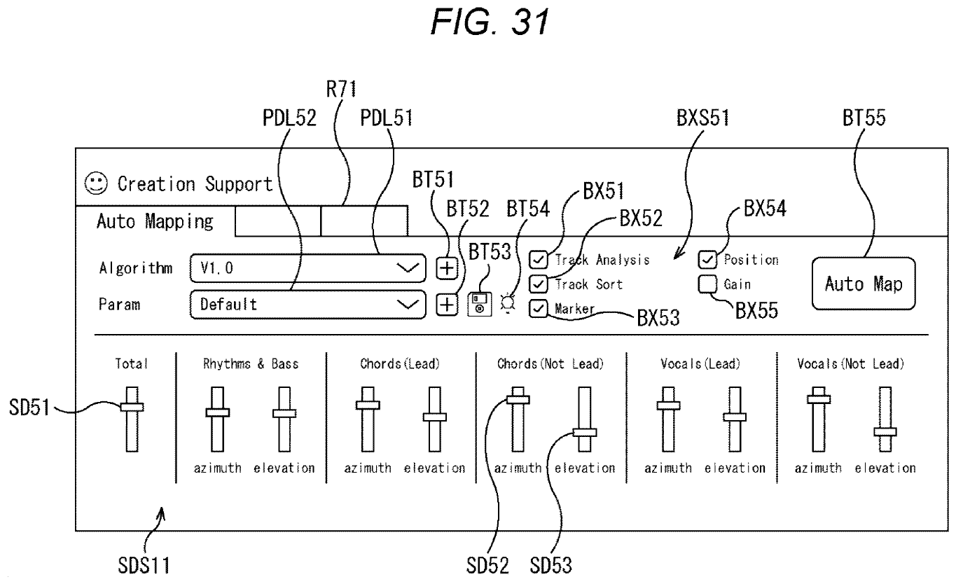

As illustrated in FIG. 31, for example, a pull-down list PDL51, a pull-down list PDL52, buttons BT51 to BT55, a check box group BXS51 including check boxes BX51 to BX55, and a slider group SDS11 are provided in the display region R71 provided in the upper part of the display region R62.

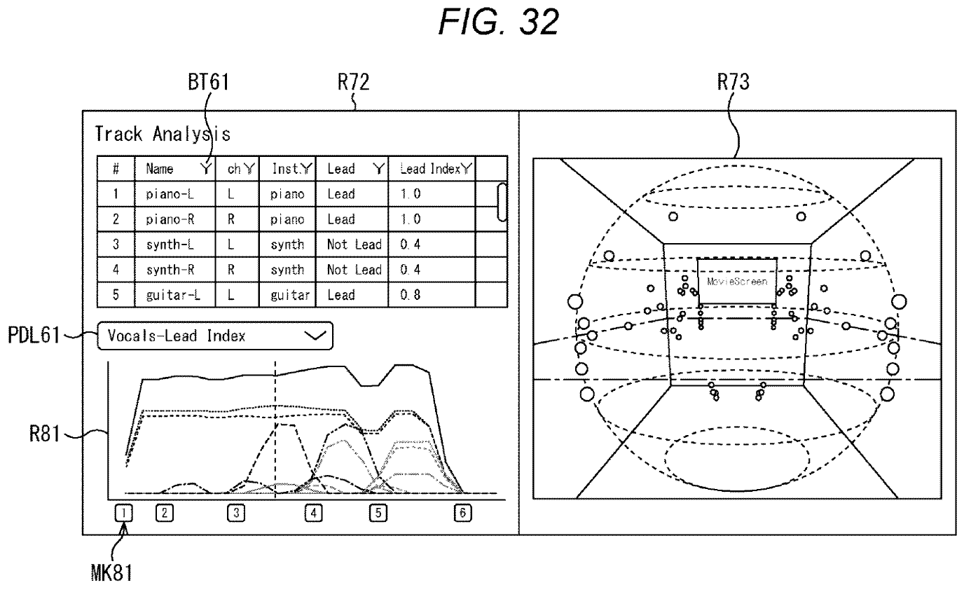

Furthermore, the attribute display region R72 and the mixing result display region R73 provided in the lower part of the display region R62 have, for example, the configuration illustrated in FIG. 32.

In this example, attribute information obtained by automatic mixing is presented in the attribute display region R72, and a pull-down list PDL61 for selecting an object feature amount as attribute information to be displayed in a display region R81 is provided.

Furthermore, a result of the automatic mixing is displayed in the mixing result display region R73. That is, a three-dimensional space is displayed in the mixing result display region R73, and spheres indicating the respective objects constituting the content are arranged in the three-dimensional space.

In particular, an arrangement position of each of the objects in the three-dimensional space is a position indicated by the three-dimensional position information as the output parameter obtained by the automatic mixing processing described with reference to FIG. 3. Therefore, the user can instantaneously grasp the arrangement position of each of the objects by viewing the mixing result display region R73.

Note that, here, the spheres indicating the objects are displayed in the same color, but more specifically, the spheres indicating the objects are displayed in colors different for each of the objects.

Next, each part of the display region R62 illustrated in FIGS. 31 and 32 will be described in more detail.

The user can select a desired algorithm from a plurality of automatic mixing algorithms by operating the pull-down list PDL51 in the display region R71 illustrated in FIG. 31.

In other words, it is possible to select an output parameter calculation function and an output parameter adjustment method in the output parameter adjustment unit 67 by the operation on the pull-down list PDL51.

In the following description, in a case of being referred to as an algorithm, the algorithm means an automatic mixing algorithm when the automatic mixing apparatus 51 calculates an output parameter from audio data of an object, which is defined by the output parameter calculation function, the output parameter adjustment method in the output parameter adjustment unit 67, or the like. Note that, if algorithms are different, pieces of attribute information calculated by these algorithms may also be different. Specifically, for example, there is a case where “rise” is calculated as an object feature amount in a predetermined algorithm, and “rise” is not calculated as an object feature amount in another algorithm different from the predetermined algorithm.

Furthermore, the user can select an internal parameter of the algorithm selected by the pull-down list PDL52 from a plurality of internal parameters by operating the pull-down list PDL51.

The slider group SDS11 includes sliders (slider bars) for adjusting internal parameters of the algorithm selected by the pull-down list PDL51, that is, internal parameters of the output parameter calculation function or internal parameters for output parameter adjustment.

As an example, in some or all of the sliders constituting the slider group SDS11, positions of a pointer on the slider may be, for example, positions in 101 stages corresponding to integer values from 0 to 100. That is, the user can move the position of the pointer on the slider to a position corresponding to any integer value from 0 to 100. The adjustable number of stages “101” of the pointer position is appropriate fineness suitable for the user's feeling.

Note that an integer value from 0 to 100 indicating a current position of the pointer of the slider may be presented to the user. For example, an integer value indicating a position of a pointer may be displayed when a mouse cursor is placed on the pointer.

Furthermore, the user can designate the position of the pointer of the slider by directly inputting an integer value from 0 to 100 with a keyboard or the like as the input unit 21. This enables fine adjustment of the position of the pointer. For example, a numerical value may be input by double-clicking the pointer of the slider to be adjusted.

The number of sliders constituting the slider group SDS11, a character string drawn to describe the meaning of each of the sliders, a method for changing an internal parameter of the algorithm when the pointer of each of the sliders is moved (slid), and an initial position of the pointer of the slider may be made different depending on the algorithm selected by the pull-down list PDL51.

Each of the sliders may adjust an internal parameter (mixing parameter) for each object category such as an instrument type.

Furthermore, for example, as illustrated in FIG. 31, internal parameters of a plurality of instrument types such as “Rhythms & Bass”, “Chords”, and “Vocals” may be collectively adjustable. Moreover, the internal parameter may be adjustable for each output parameter such as azimuth (azimuth angle) or elevation (elevation angle).

In this example, for example, by operating a pointer SD52 on a slider, the user can adjust the internal parameters related to azimuth (azimuth angle) in the output parameter calculation function or the like for an object that is an accompaniment instrument corresponding to an instrument type “Chords” and the role of “Not Lead”.

Similarly, for example, the user operates a pointer SD53 on a slider to adjust the internal parameter related to elevation (elevation angle) in the output parameter calculation function or the like for the object that is the accompaniment instrument corresponding to the instrument type “Chords” and the role of “Not Lead”.

Furthermore, among the sliders constituting the slider group SDS11, a slider provided at a portion where characters “Total” are written is a slider that can collectively operate all the sliders.

That is, the user can collectively operate pointers on all the sliders provided on the right side of the slider in the drawing by operating a pointer SD51 on the slider.

By providing the slider capable of collectively operating the plurality of sliders in this manner, a content production time can be further shortened.

Note that, in the operation on the slider, lowering the pointer on the slider may reduce spatial spread of a corresponding object group, and raising the pointer on the slider may increase the spatial spread of the corresponding object group.

Furthermore, conversely, lowering the pointer on the slider may increase the spatial spread of the corresponding object group, and raising the pointer on the slider may reduce the spatial spread of the corresponding object group.

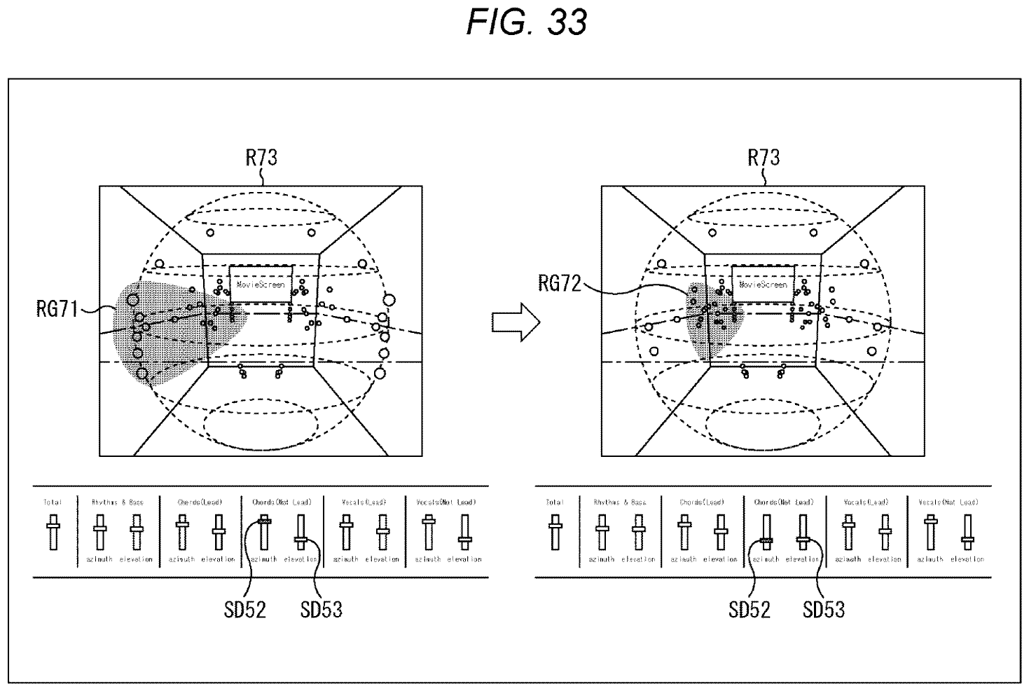

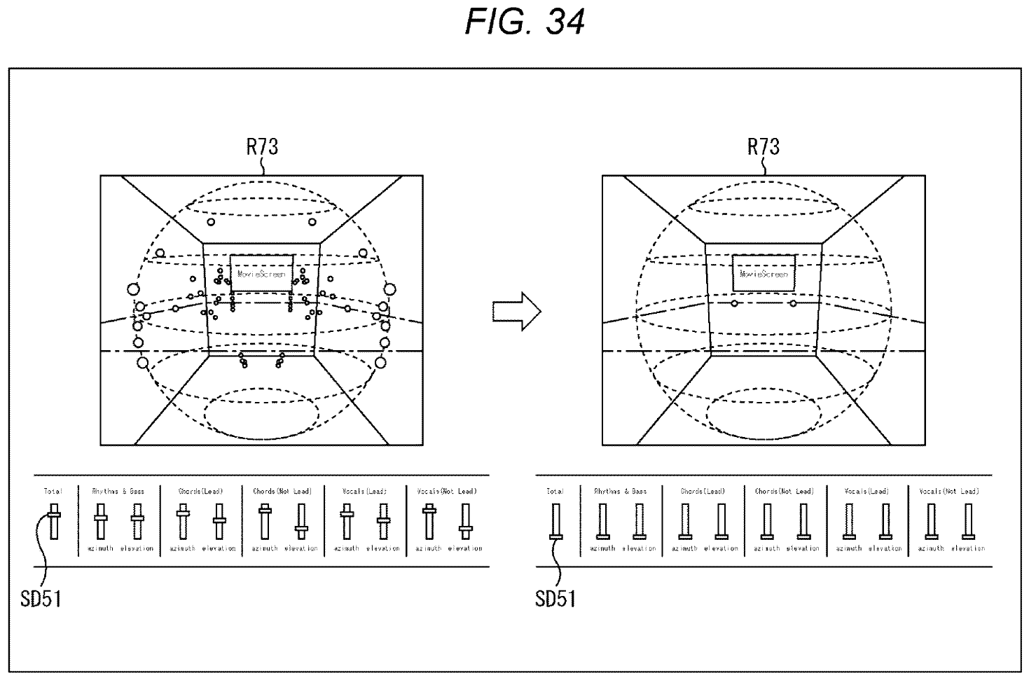

Here, an example in which a result of automatic mixing changes depending on positions of pointers on sliders is illustrated in FIGS. 33 and 34.

In FIGS. 33 and 34, display examples of the mixing result display region R73 before and after a change by operations on the sliders are illustrated on the upper side in the drawing, and the slider group SDS11 is illustrated on the lower side in the drawing. Note that, in FIGS. 33 and 34, portions corresponding to those in the case of FIG. 31 or 32 are denoted by the same reference signs, and a description thereof will be omitted as appropriate.

In FIG. 33, a display of the mixing result display region R73 before the operation with respect to the pointers SD52 on the sliders is illustrated on the left side in the drawing, and a display of the mixing result display region R73 after the operation with respect to the pointer SD52 is illustrated on the right side in the drawing.

In this example, it can be seen that the spatial spread in the horizontal direction of an object group corresponding to “Chords (Not Lead)”, that is, an accompaniment instrument group is reduced by lowering a position of the pointer SD52 on the slider for “azimuth” of “Chords (Not Lead)”.

That is, before the operation of the slider, objects of accompaniment instruments distributed in a relatively wide region RG71 are gathered close to each other by the operation on the slider, and arrangement positions of the respective objects are changed so as to be located in a narrower region RG72.

Furthermore, in FIG. 34, the display of the mixing result display region R73 before the operation with respect to the pointer SD51 on the slider is illustrated on the left side in the drawing, and a display of the mixing result display region R73 after the operation with respect to the pointer SD51 is illustrated on the right side in the drawing.

In this example, the pointers of all the sliders are lowered to the bottom by lowering the pointer SD51 on the slider, configured for the collective operation, to the bottom.

By such an operation, all the objects are arranged at a position of azimuth=30° and elevation=0°. That is, the internal parameters are adjusted by the parameter adjustment unit 69 (the control unit 26) such that the arrangement positions of all the objects are the same. Therefore, the content becomes stereo content.

Returning to the description of FIG. 31, the button BT55 is provided on the right side in the display region R71.

The button BT55 is an execution button for instructing execution of automatic mixing by the algorithm (output parameter calculation function or the like) and internal parameters set by the operations on the pull-down list PDL51, the pull-down list PDL52, and the slider group SDS11.

When the button BT55 is operated by the user, the automatic mixing processing of FIG. 3 is executed, and the displays of the mixing result display region R73 and the attribute display region R72 are updated according to the output parameters obtained as a result. That is, the control unit 26 controls the display unit 22 to display the result of the automatic mixing processing, that is, the determination result of the output parameters, in the mixing result display region R73, and also updates the display of the attribute display region R72 as appropriate.

At this time, in step S15, the output parameter calculation function corresponding to the algorithm set (designated) by the pull-down list PDL51 is selected. Furthermore, as an internal parameter of the selected output parameter calculation function, for example, an internal parameter of an object category of an object to be processed is selected among a plurality of internal parameters set for each of the object categories by the operations on the pull-down list PDL52 and the slider group SDS11.

Furthermore, in step S17, internal parameters according to operations on the pull-down list PDL51, the pull-down list PDL52, and the slider group SDS11 are selected, and the output parameters are adjusted on the basis of the selected internal parameters.

Note that remixing may be performed instantaneously to update the display of the mixing result display region R73 when the user operates the slider group SDS11, that is, adjusts the internal parameters after performing the automatic mixing using the button BT55.

In this case, when the user performs an operation on the slider group SDS11 after the automatic mixing processing of FIG. 3 is performed once, the control unit 26, that is, the automatic mixing apparatus 51 performs the processing of steps S15 to S18 in the automatic mixing processing on the basis of the adjusted internal parameters according to the operation, and updates the display of the mixing result display region R73 according to the output parameters obtained as a result. At this time, processing results of steps S12 to S14 in the first automatic mixing processing that has already been performed are used in the automatic mixing processing to be performed again.

In this manner, the user can adjust the sliders of the slider group SDS11 so as to obtain his/her preferred mixing result while confirming the mixing result in the mixing result display region R73. Moreover, in this case, the user can execute the automatic mixing processing again only by operating the slider group SDS11 without operating the button BT55.

In the automatic mixing processing, the most time is required for the processing of steps S12 to S14, which is the processing (preceding-stage processing) of calculating the attribute information, that is, the content category, the object category, and the object feature amount. On the other hand, processing (subsequent-stage processing) of determining the output parameters on the basis of a result of the preceding-stage processing, that is, the processing of steps S15 to S18 can be performed in a very short time.

Therefore, the preceding-stage processing can be skipped if the subsequent-stage processing, that is, only the output parameter adjustment is performed by the sliders of the slider group SDS11, and thus, remixing can be instantaneously performed following adjustment of the sliders.

Furthermore, the attribute display region R72 illustrated in FIG. 32 is a display region for presenting the attribute information calculated by the automatic mixing processing to the user, and the attribute information and the like are displayed in the attribute display region R72 as the control unit 26 controls the display unit 22. In the attribute display region R72, the displayed attribute information may be different for each automatic mixing algorithm selected by the pull-down list PDL51. This is because the calculated attribute information may be different for each algorithm.

When the attribute information is presented to the user, there is an advantage that the user can easily understand the behavior of the algorithm (the output parameter calculation function and the output parameter adjustment). Furthermore, the presentation of the attribute information makes it easier for the user to understand a configuration of music.

In the example of FIG. 32, an attribute information list for each of the objects is displayed in the upper part in the attribute display region R72.

That is, in the attribute information list, a track number of an object, an object name, a channel name, an instrument type and a role as an object category, and a Lead index as an object feature amount are displayed for each of the objects.

Furthermore, in the attribute information list, a narrowing button for narrowing down display contents in the attribute information list is displayed for each field. That is, the user can narrow down the display contents of the attribute information list under a specified condition by operating the narrowing button such as a button BT61.

Specifically, for example, attribute information can be displayed only for objects whose instrument type is “piano”, or attribute information can be displayed only for objects whose role is “Lead”. At this time, only a result of mixing the objects narrowed down by the narrowing button such as the button BT61 may be displayed in the mixing result display region R73.

In the display region R81, the object feature amounts selected by the pull-down list PDL61 among the object feature amounts calculated by the automatic mixing processing are displayed in time series.

That is, the user can cause the object feature amounts, designated by himself or herself in the entire content or a partial section to be mixed, to be displayed in time series in the display region R81 by operating the pull-down list PDL61.

In this example, a time-series change in the Lead index of a vocal group designated by the pull-down list PDL61, that is, objects whose instrument type of the object category is “vocal” is displayed in the display region R81.

When the object feature amounts are presented to the user in time series in this manner, there is an advantage that the user can easily understand the behavior of the algorithm (the output parameter calculation function and the output parameter adjustment) and the configuration of music. Note that the object feature amount that can be designated by the pull-down list PDL61, that is, the object feature amount displayed in the pull-down list PDL61 may be different for each automatic mixing algorithm selected by the pull-down list PDL51. This is because the calculated object feature amount may be different for each algorithm.

The check box group BXS51 illustrated in FIG. 31 includes the check boxes BX51 to BX55 for changing the automatic mixing settings.

The user can change the check boxes to either an ON state or an OFF state by operating these check boxes. Here, a state in which a check mark is displayed in the check box is the ON state, and a state in which no check mark is displayed in the check box is the OFF state.

For example, the check box BX51 displayed together with characters “Track Analysis” is for automatic calculation of attribute information.

That is, when the check box BX51 is set to the ON state, the automatic mixing apparatus 51 calculates the attribute information on the basis of the audio data of the object.

On the other hand, when the check box BX51 is set to the OFF state, automatic mixing is performed using attribute information manually input by the user in the attribute information list in the attribute display region R72.

Furthermore, the check box BX51 may be set to the ON state to execute automatic mixing, and attribute information calculated by the automatic mixing apparatus 51 is displayed in the attribute information list, and then, the user may manually adjust the attribute information displayed in the attribute information list.

In such a case, after the user adjusts the attribute information, automatic mixing can be executed again by setting the check box BX51 to the OFF state and operating the button BT55. In this case, automatic mixing processing is performed using the attribute information adjusted by the user.

Since there may be an error in the attribute information automatically calculated by the automatic mixing apparatus 51, more ideal automatic mixing can be performed by performing automatic mixing again after the user corrects the error.

A check box BX52 displayed together with characters “Track Sort” is configured to automatically sort the display order of objects.

That is, the user can sort attribute information for each of the objects in the attribute information list in the attribute display region R72 and displays of object names and the like in the display region R61 by setting the check box BX52 to the ON state.

Note that the attribute information calculated by the automatic mixing processing may be used for the sorting. In such a case, for example, sorting into the display order based on the instrument type or the like as the object category can be performed.

A check box BX53 displayed together with characters “Marker” is configured for automatic detection of switching of a scene such as Melo A, Melo B, or Refrain in the content.

When the user sets the check box BX53 to the ON state, the automatic mixing apparatus 51, that is, the control unit 26 detects switching of a scene in the content on the basis of the audio data of each of the objects, and displays a detection result in the display region R72 in the attribute display region R81. In the example of FIG. 32, for example, a mark MK81 indicating a position in the display region R81 indicates a detected position of the scene switching. Note that the attribute information obtained by the automatic mixing processing may be used to detect the scene switching.

In the check box group BXS51 illustrated in FIG. 31, a check box BX54 displayed together with characters “Position” is used to replace three-dimensional position information in the output parameters with a result of the automatic mixing processing that is newly performed.

That is, when the user sets the check box BX54 to the ON state, the azimuth angle (azimuth) and the elevation angle (elevation) of the output parameters of each of the objects are replaced with an azimuth angle and an elevation angle obtained as output parameters in the automatic mixing processing newly performed by the automatic mixing apparatus 51. That is, those obtained by the automatic mixing processing are adopted as the azimuth angle and the elevation angle of the output parameters.

On the other hand, in a case where the check box BX54 is in the OFF state, the azimuth angle and the elevation angle as the output parameters are not replaced with a result of the automatic mixing processing. That is, as the azimuth angle and the elevation angle of the output parameters, those already obtained by the automatic mixing processing, those input by the user, those read as metadata of the content, those set in advance, or the like are adopted.

Therefore, for example, when it is desired to perform the automatic mixing processing once, thereafter, adjust the internal parameters and the like, and recalculate only the gain as the output parameter, it is only required to set the check box BX54 to the OFF state, set the check box BX55 as described later to the ON state, and operate the button BT55.

In this case, when automatic mixing processing is newly performed on the basis of the adjusted internal parameters and the like, the gain of the output parameters is replaced with a gain obtained by the new automatic mixing processing. On the other hand, regarding the azimuth angle and the elevation angle as the output parameters, an azimuth angle and an elevation angle at a current time point remain without being replaced with an azimuth angle and an elevation angle obtained as a result of the new automatic mixing processing.

Furthermore, the check box BX55 displayed together with characters “Gain” is configured to replace the gain of the output parameters with a result of the automatic mixing processing that is newly performed.

That is, when the user sets the check box BX55 to the ON state, the gain of the output parameters of each of the objects is replaced with a gain obtained as an output parameter in the automatic mixing processing newly performed by the automatic mixing apparatus 51. That is, one obtained by the automatic mixing processing is adopted as the gain of the output parameters.

On the other hand, in a case where the check box BX55 is in the OFF state, the gain as the output parameter is not replaced with a result of the automatic mixing processing. That is, as the gain of the output parameters, one already obtained by the automatic mixing processing, one input by the user, one read as metadata of the content, one set in advance, or the like is adopted.

The check box BX54 and the check box BX55 are user interfaces for designating whether to replace one or a plurality of specific output parameters such as the gain among the plurality of output parameters with an output parameter newly determined by the automatic mixing processing.

Moreover, the button BT51 provided in the display region R71 of FIG. 31 is a button for adding a new algorithm of the automatic mixing.

When the button BT51 is operated by the user, the information processing apparatus 11, that is, the control unit 26 downloads a latest algorithm developed by a developer of an automatic mixing algorithm, that is, an internal parameter of a new output parameter calculation function and an internal parameter for output parameter adjustment from a server (not illustrated) or the like via the communication unit 24 or the like, supplies the same to the parameter holding unit 70 to be held therein. After the button BT51 is operated and download is performed, the user can use the new (latest) algorithm that has not been used before as an automatic mixing algorithm. That is, it is possible to use the new algorithm of automatic mixing that is obtained by the download and corresponds to the new output parameter calculation function and output parameter adjustment method. In this case, in the new algorithm added by the download, new attribute information that has not been used in the previous algorithm may be used (calculated).

Note that, as the latest algorithm, only information indicating the new output parameter calculation function and output parameter adjustment method may be downloaded. Furthermore, not only the information indicating the new output parameter calculation function and output parameter adjustment method but also the internal parameters used in the new output parameter calculation function and output parameter adjustment method may be downloaded.

The button BT53 is a button for storing an internal parameter of the algorithm of automatic mixing, that is, a position of a pointer in each slider constituting the slider group SDS11.

When the button BT53 is operated by the user, the internal parameter corresponding to the position of the pointer in each of the sliders constituting the slider group SDS11 is stored in the parameter holding unit 70 by the control unit 26 (the parameter adjustment unit 69) as an adjusted internal parameter.

Note that the internal parameter can be stored with any name, and the stored internal parameter can be selected (read) by the pull-down list PDL52 on and after the next time. Furthermore, a plurality of the internal parameters can be stored.

Moreover, the internal parameter can be stored locally (in the parameter holding unit 70), can be exported to the outside as a file and can be passed to another user, or can be stored in an online server such that users in the world can use the internal parameter.

The button BT52 is a button for adding an internal parameter of the algorithm of automatic mixing, in other words, a position of a pointer in each of the sliders constituting the slider group SDS11. That is, the button BT52 is a button for additionally acquiring a new internal parameter.

When the user operates the button BT52, it is possible to read an internal parameter exported as a file by another user, download and read internal parameters of users in the world stored in the online server, or download and read a parameter of a famous mixing engineer.

In response to the operation of the button BT52 by the user, the control unit 26 acquires an internal parameter from an external apparatus such as the online server via the communication unit 24, or acquires an internal parameter from a recording medium or the like connected to the information processing apparatus 11. Then, the control unit 26 supplies the acquired internal parameter to the parameter holding unit 70 to be held therein.

A taste regarding mixing of an individual is condensed in the internal parameters adjusted by the individual, and a mechanism of sharing such internal parameters enables the taste of the mixing of the individual to be shared with the other or enables a taste of mixing of the other to be incorporated in the individual.

A button BT54 is a recommended button configured to propose (present) a recommended automatic mixing algorithm or internal parameter of an automatic mixing algorithm to the user.

For example, when the button BT54 is operated by the user, the control unit 26 determines an algorithm or an internal parameter to be recommended to the user on the basis of a log (hereinafter, also referred to as a past use log) when the user performed mixing using the 3D audio production/editing tool in the past.

Specifically, for example, the control unit 26 can calculate a degree of recommendation for each algorithm or internal parameter on the basis of the past use log, and present an algorithm or an internal parameter with a high degree of recommendation to the user.

In this case, for example, for audio data of content mixed in the past, an algorithm or an internal parameter that can obtain an output parameter close to (similar to) an output parameter that is an actual mixing result for the audio data can be made to have a higher degree of recommendation.

Furthermore, for example, the control unit 26 can specify a most frequently used content category among content categories of a plurality of pieces of content subjected to mixing by the user in the past on the basis of the past use log, and can use an algorithm or an internal parameter most suitable for the specified content category as the algorithm or internal parameter recommended to the user.

Note that the algorithm or internal parameter recommended to the user may be an internal parameter already held in the parameter holding unit 70 or an algorithm that uses the internal parameter, or may be an algorithm or an internal parameter newly generated by the control unit 26 on the basis of the past use log.

When the recommended algorithm or internal parameter is determined, the control unit 26 controls the display unit 22 to present the recommended algorithm and the internal parameter to the user, but any method may be used as a method for the presentation.

As a specific example, for example, the control unit 26 may present the recommended algorithm and internal parameter to the user by setting displays of the pull-down list PDL51 and the pull-down list PDL52 and positions of the pointers on the sliders constituting the slider group SDS11 to displays and positions according to the recommended algorithm and internal parameter.

Furthermore, when the button BT54 is operated by the user, the automatic optimization processing of FIG. 26 may be performed, and a result of the processing may be presented to the user.

Meanwhile, the automatic mixing processing of FIG. 3, the automatic optimization processing of FIG. 26, and the operation on the display region R62 of the display screen of the 3D audio production/editing tool and the display update described above may be performed for the entire content, or may be performed for a partial section of the content.

Therefore, for example, at the time of the automatic mixing processing, the algorithm or the internal parameter may be manually or automatically switched for each time section corresponding to the scene such as Melo A, or the display of the attribute information in the attribute display region R72 may be updated for each time section. In particular, for example, the automatic mixing algorithm or the internal parameter may be switched or the display of each part of the display region R62 may be switched for each switching position of the scene indicated by the mark MK81 or the like in the display region R81 of FIG. 32 detected according to the operation on the check box BX53.

### <Configuration Example of Computer>

Meanwhile, series of the processing described above can be executed by hardware or can be executed by software. In a case where the series of processing is executed by the software, a program forming the software is installed on a computer. Here, examples of the computer include a computer incorporated in dedicated hardware, and for example, a general-purpose personal computer capable of executing various functions by installing various programs.

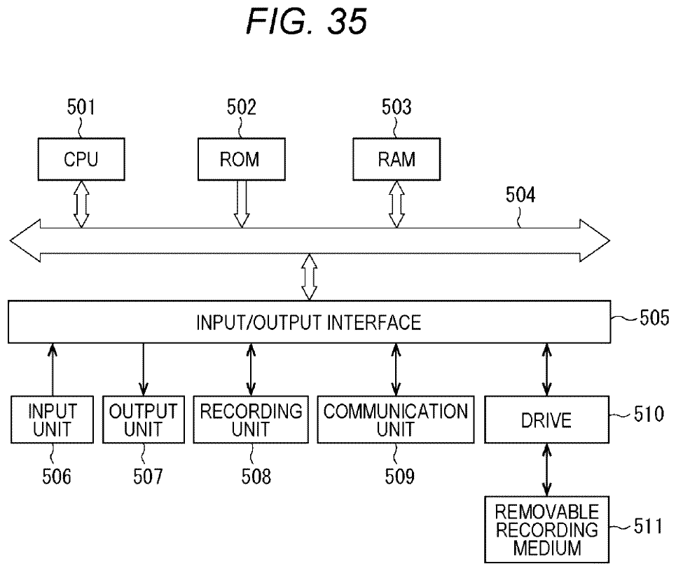

FIG. 35 is a block diagram illustrating a configuration example of hardware of a computer that executes the above-described series of processing with a program.

In the computer, a central processing unit (CPU) 501, a read only memory (ROM) 502, and a random access memory (RAM) 503 are mutually connected by a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker, and the like. The recording unit 508 includes a hard disk, a non-volatile memory and the like. The communication unit 509 includes a network interface and the like. The drive 510 drives a removable recording medium 511 such as a magnetic disk, an optical disk, a magneto-optical disk, or a semiconductor memory.

In the computer configured as described above, for example, the CPU 501 loads a program recorded in the recording unit 508 into the RAM 503 via the input/output interface 505 and the bus 504 and executes the program, whereby the above-described series of processing is performed.

The program executed by the computer (CPU 501) can be provided by being recorded on the removable recording medium 511 as a package medium and the like, for example. Furthermore, the program may be provided via a wired or wireless transmission medium, such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program that performs processing in a time-series manner in the order described in the present description, or may be a program that performs processing in parallel or at necessary timing such as when a call is made.

Furthermore, the embodiment of the present technology is not limited to the above-described embodiment and various modifications may be made without departing from the scope of the present technology.

For example, the present technology may be configured as cloud computing in which a function is shared by a plurality of apparatuses via a network to process together.

Furthermore, each of the steps described in the above-described flowcharts can be executed by one apparatus or executed by a plurality of apparatuses in a shared manner.

Moreover, in a case where a plurality of processing steps is included in one step, the plurality of processing included in the one step can be performed by one apparatus or shared and performed by a plurality of apparatuses.

Moreover, the present technology may also have following configurations.

(1)

An information processing apparatus including
a control unit that determines an output parameter forming metadata of an object of content on the basis of the content or one or a plurality of pieces of attribute information of the object.
   (2)

The information processing apparatus according to (1), in which
the content is 3D audio content.
   (3)

The information processing apparatus according to (1) or (2), in which
the output parameter is at least any of three-dimensional position information and a gain of the object.
   (4)

The information processing apparatus according to any one of (1) to (3), in which
the control unit calculates the attribute information on the basis of audio data of the object.
   (5)

The information processing apparatus according to any one of (1) to (4), in which
the attribute information is a content category indicating a type of the content, an object category indicating a type of the object, or an object feature amount indicating a feature of the object.
   (6)

The information processing apparatus according to (5), in which
the attribute information is indicated by a character or a numerical value that is understandable by a user.
   (7)

The information processing apparatus according to (5) or (6), in which
the content category is at least any of a genre, a tempo, a tonality, a feeling, a recording type, and presence or absence of a video.
   (8)

The information processing apparatus according to any one of (5) to (7), in which
the object category is at least any of an instrument type, a reverb type, a tone type, a priority, and a role.
   (9)

The information processing apparatus according to any one of (5) to (8), in which
the object feature amount is at least any of a rise, duration, a sound pitch, a note density, a reverb intensity, a sound pressure, a time occupancy rate, a tempo, and a Lead index.
   (10)

The information processing apparatus according to any one of (5) to (9), in which
the control unit determines the output parameter for each of the objects on the basis of a mathematical function having the object feature amount as an input.
   (11)

The information processing apparatus according to (10), in which
the control unit determines the mathematical function on the basis of at least any one of the content category or the object category.
   (12)

The information processing apparatus according to (10) or (11), in which
the control unit adjusts the output parameter of the object on the basis of determination results of the output parameter based on the mathematical function obtained for a plurality of the objects.
   (13)

The information processing apparatus according to any one of (1) to (12), in which
the control unit displays a user interface for adjusting or selecting an internal parameter to be used for determination of the output parameter based on the attribute information, and adjusts the internal parameter or selects the internal parameter in accordance with an operation on the user interface by a user.
   (14)

The information processing apparatus according to (13), in which
the internal parameter is a parameter of a mathematical function for determining the output parameter with an object feature amount indicating a feature of the object as the attribute information as an input, or a parameter for adjusting the output parameter of the object on the basis of a determination result of the output parameter on the basis of the mathematical function.
   (15)

The information processing apparatus according to any one of (1) to (14), in which
the control unit optimizes an internal parameter to be used for determination of the output parameter based on the attribute information on the basis of audio data of each of the objects of a plurality of pieces of the content designated by a user and the output parameter of each of the objects of the plurality of pieces of the content determined by the user.
   (16)

The information processing apparatus according to any one of (5) to (12), in which
a range of the output parameter is defined in advance for each of the object categories, and
the control unit determines the output parameter of the object in the object category in such a manner that the output parameter has a value within the range.
   (17)

The information processing apparatus according to any one of (1) to (16), in which
the control unit causes the attribute information to be displayed on a display screen of a tool configured to produce or edit the content.
   (18)

The information processing apparatus according to (17), in which
the control unit causes the display screen to display a determination result of the output parameter.
   (19)

The information processing apparatus according to (17) or (18), in which
the control unit causes the display screen to display an object feature amount indicating a feature of the object as the attribute information.
   (20)

The information processing apparatus according to (19), in which
the display screen is provided with a user interface for selecting the object feature amount to be displayed.
   (21)

The information processing apparatus according to any one of (17) to (20), in which
the display screen is provided with a user interface for adjusting an internal parameter to be used for determination of the output parameter based on the attribute information.
   (22)

The information processing apparatus according to (21), in which
the control unit determines the output parameter again on the basis of the adjusted internal parameter in accordance with an operation on the user interface for adjusting the internal parameter, and updates display of a determination result of the output parameter on the display screen.
   (23)

The information processing apparatus according to (21) or (22), in which
the display screen is provided with a user interface for storing the adjusted internal parameter.
   (24)

The information processing apparatus according to any one of (17) to (23), in which
the display screen is provided with a user interface for selecting an internal parameter to be used for determination of the output parameter based on the attribute information.
   (25)

The information processing apparatus according to any one of (17) to (24), in which
the display screen is provided with a user interface for adding a new internal parameter to be used for determination of the output parameter based on the attribute information.
   (26)

The information processing apparatus according to any one of (17) to (25), in which
the display screen is provided with a user interface for selecting an algorithm for determination of the output parameter based on the attribute information.
   (27)

The information processing apparatus according to any one of (17) to (26), in which
the display screen is provided with a user interface for adding a new algorithm for determination of the output parameter based on the attribute information.
   (28)

The information processing apparatus according to any one of (17) to (27), in which
the display screen is provided with a user interface for designating whether to replace a specific output parameter among a plurality of the output parameters with an output parameter newly determined on the basis of the attribute information.
   (29)

The information processing apparatus according to any one of (17) to (28), in which
the display screen is provided with a user interface for presenting a recommended algorithm or a recommended internal parameter as the algorithm for determination of the output parameter based on the attribute information or the internal parameter used for the determination of the output parameter based on the attribute information.
   (30)

An information processing method including
determining, by an information processing apparatus, an output parameter forming metadata of an object of content on the basis of the content or one or a plurality of pieces of attribute information of the object.
   (31)

A program for causing a computer to execute processing including
determining an output parameter constituting metadata of an object of content on the basis of the content or one or a plurality of pieces of attribute information of the object.

### REFERENCE SIGNS LIST

11 Information processing apparatus
21 Input unit
22 Display unit
25 Audio output unit
26 Control unit
51 Automatic mixing apparatus
62 Object feature amount calculation unit
63 Object category calculation unit
64 Content category calculation unit
65 Output parameter calculation function determination unit
66 Output parameter calculation unit
67 Output parameter adjustment unit
69 Parameter adjustment unit
70 Parameter holding unit
106 Optimization unit

1. An information processing apparatus comprising
a control unit that determines an output parameter forming metadata of an object of content on a basis of the content or one or a plurality of pieces of attribute information of the object.

2. The information processing apparatus according to claim 1, wherein
the content is 3D audio content.

3. The information processing apparatus according to claim 1, wherein
the output parameter is at least any of three-dimensional position information and a gain of the object.

4. The information processing apparatus according to claim 1, wherein
the control unit calculates the attribute information on a basis of audio data of the object.

5. The information processing apparatus according to claim 1, wherein
the attribute information is a content category indicating a type of the content, an object category indicating a type of the object, or an object feature amount indicating a feature of the object.

6. The information processing apparatus according to claim 5, wherein
the attribute information is indicated by a character or a numerical value that is understandable by a user.

7. The information processing apparatus according to claim 5, wherein
the content category is at least any of a genre, a tempo, a tonality, a feeling, a recording type, and presence or absence of a video.

8. The information processing apparatus according to claim 5, wherein
the object category is at least any of an instrument type, a reverb type, a tone type, a priority, and a role.

9. The information processing apparatus according to claim 5, wherein
the object feature amount is at least any of a rise, duration, a sound pitch, a note density, a reverb intensity, a sound pressure, a time occupancy rate, a tempo, and a Lead index.

10. The information processing apparatus according to claim 5, wherein
the control unit determines the output parameter for each of the objects on a basis of a mathematical function having the object feature amount as an input.

11. The information processing apparatus according to claim 10, wherein
the control unit determines the mathematical function on a basis of at least any one of the content category or the object category.

12. The information processing apparatus according to claim 10, wherein
the control unit adjusts the output parameter of the object on a basis of determination results of the output parameter based on the mathematical function obtained for a plurality of the objects.

13. The information processing apparatus according to claim 1, wherein
the control unit displays a user interface for adjusting or selecting an internal parameter to be used for determination of the output parameter based on the attribute information, and adjusts the internal parameter or selects the internal parameter in accordance with an operation on the user interface by a user.

14. The information processing apparatus according to claim 13, wherein
the internal parameter is a parameter of a mathematical function for determining the output parameter with an object feature amount indicating a feature of the object as the attribute information as an input, or a parameter for adjusting the output parameter of the object on the basis of a determination result of the output parameter on the basis of the mathematical function.

15. The information processing apparatus according to claim 1, wherein
the control unit optimizes an internal parameter to be used for determination of the output parameter based on the attribute information on a basis of audio data of each of the objects of a plurality of pieces of the content designated by a user and the output parameter of each of the objects of the plurality of pieces of the content determined by the user.

16. The information processing apparatus according to claim 5, wherein
a range of the output parameter is defined in advance for each of the object categories, and
the control unit determines the output parameter of the object in the object category in such a manner that the output parameter has a value within the range.

17. The information processing apparatus according to claim 1, wherein
the control unit causes the attribute information to be displayed on a display screen of a tool configured to produce or edit the content.

18. The information processing apparatus according to claim 17, wherein
the control unit causes the display screen to display a determination result of the output parameter.

19. The information processing apparatus according to claim 17, wherein
the control unit causes the display screen to display an object feature amount indicating a feature of the object as the attribute information.

20. The information processing apparatus according to claim 19, wherein
the display screen is provided with a user interface for selecting the object feature amount to be displayed.

21. The information processing apparatus according to claim 17, wherein
the display screen is provided with a user interface for adjusting an internal parameter to be used for determination of the output parameter based on the attribute information.

22. The information processing apparatus according to claim 21, wherein
the control unit determines the output parameter again on a basis of the adjusted internal parameter in accordance with an operation on the user interface for adjusting the internal parameter, and updates display of a determination result of the output parameter on the display screen.

23. The information processing apparatus according to claim 21, wherein
the display screen is provided with a user interface for storing the adjusted internal parameter.

24. The information processing apparatus according to claim 17, wherein
the display screen is provided with a user interface for selecting an internal parameter to be used for determination of the output parameter based on the attribute information.

25. The information processing apparatus according to claim 17, wherein
the display screen is provided with a user interface for adding a new internal parameter to be used for determination of the output parameter based on the attribute information.

26. The information processing apparatus according to claim 17, wherein
the display screen is provided with a user interface for selecting an algorithm for determination of the output parameter based on the attribute information.

27. The information processing apparatus according to claim 17, wherein
the display screen is provided with a user interface for adding a new algorithm for determination of the output parameter based on the attribute information.

28. The information processing apparatus according to claim 17, wherein
the display screen is provided with a user interface for designating whether to replace a specific output parameter among a plurality of the output parameters with an output parameter newly determined on a basis of the attribute information.

29. The information processing apparatus according to claim 17, wherein
the display screen is provided with a user interface for presenting a recommended algorithm or a recommended internal parameter as the algorithm for determination of the output parameter based on the attribute information or the internal parameter used for the determination of the output parameter based on the attribute information.

30. An information processing method comprising
determining, by an information processing apparatus, an output parameter forming metadata of an object of content on a basis of the content or one or a plurality of pieces of attribute information of the object.

31. A program for causing a computer to execute processing comprising
determining an output parameter constituting metadata of an object of content on a basis of the content or one or a plurality of pieces of attribute information of the object.
